(19) United States
(12) Patent Application Publication
(10) Pub. No.: US 2013/0116865 A1
(43) Pub. Date: May 9, 2013

(54) SYSTEM AND METHOD FOR CHANGING WHEN A VEHICLE ENTERS A VEHICLE YARD

(71) Applicants: Jared Cooper, Melbourne, FL (US); Mason Samuels, Melbourne, FL (US)

(72) Inventors: Jared Cooper, Melbourne, FL (US); Mason Samuels, Melbourne, FL (US)

(21) Appl. No.: 13/288,391

(22) Filed: Nov. 3, 2011

(51) Int. Cl. G05D 1/00

(52) U.S. Cl. 701/20

(57) ABSTRACT

A system includes a control unit that is configured to be disposed on-board a first vehicle that moves along a route of a transportation network having a vehicle yard. The control unit also is configured to receive, from off-board the first vehicle, an updated time of entry into the vehicle yard for the approaching vehicle and to change a speed of the first vehicle in response to the updated time of entry. A method includes receiving an updated time of entry into a vehicle yard at a first vehicle that is moving along a route of a transportation network that includes the vehicle yard and changing a speed of the first vehicle in response to the updated time of entry. The updated time is received from off-board the first vehicle.

### BACKGROUND

A transportation network for vehicles can include several interconnected main routes on which separate vehicles travel between locations. For example, a transportation network may be formed from interconnected railroad tracks with rail vehicles traveling along the tracks. The vehicles may travel according to schedules that dictate where and when the vehicles are to travel in the transportation network. The schedules may be coordinated with each other in order to arrange for certain vehicles to arrive at various locations in the transportation network at desired times and/or in a desired order.

The transportation network can include a vehicle yard, such as a rail yard that includes a relatively dense grouping of routes or locations where several vehicles can congregate. As the vehicles travel through the transportation network, one or more vehicles may travel to a vehicle yard for storage, maintenance, refueling, reordering with other vehicles, and the like. The times at which the vehicles are to travel to and enter into the vehicle yards may be dictated by the schedules of the vehicles.

But, due to unforeseen circumstances, such as damage to routes in the transportation network, unplanned maintenance to one or more vehicles, accidents, and the like, one or more vehicles may fall behind their associated schedules. Falling behind the schedules can cause the vehicles to enter into and/or leave a vehicle yard at a different time than previously scheduled. As a result, the number of vehicles in a vehicle yard may vary from a previously scheduled or planned number.

The capacity of vehicle yards to receive vehicles may vary as the numbers of vehicles in the vehicle yards change. If a vehicle is scheduled to enter into a vehicle yard at a time when the vehicle yard has insufficient capacity to enter into the yard, the vehicle may need to stop outside of the vehicle yard and wait for the capacity to increase so that the vehicle can enter into the vehicle yard. For example, a train having one or more locomotives and several cars may be unable to fit into a rail yard when other locomotives, cars, or other vehicles are in the rail yard and there is not enough room to receive the additional locomotive and cars of the train. As a result, the vehicle waiting to enter the vehicle yard may waste resources such as time, fuel, and/or operator time, and/or generate additional emissions while waiting for the capacity of the vehicle yard to increase.

A need exists for changing previously scheduled times that vehicles are to enter into a vehicle yard in order to reduce the wasting of resources and/or the generation of emissions when vehicles are forced to wait for space to open up in the vehicle yard to accept the vehicles.

### BRIEF DESCRIPTION

In one embodiment, a system includes a control unit that is configured to be disposed on-board a first vehicle that moves along a route of a transportation network having a vehicle yard. As used herein, the terms “module” or “unit” may include a hardware and/or software system that operates to perform one or more functions. For example, a module or unit may include a computer processor, controller, or other logic-based device that performs operations based on instructions stored on a tangible and non-transitory computer readable storage medium, such as a computer memory. Alternatively, a module or unit may include a hard-wired device that performs operations based on hard-wired logic of the device. The modules and units shown in the attached figures may represent the hardware that operates based on software or hardwired instructions, the software that directs hardware to perform the operations, or a combination thereof.

Also as used herein, the term “vehicle yard” can refer to a grouping of interconnected routes, such as interconnected railroad tracks, that are disposed relatively close to each other and/or where several vehicles can concurrently stop for maintenance, refueling, re-ordering of the vehicles relative to each other, and the like. For example, a vehicle yard can include routes that are more densely packed relative to the density of the routes outside of the vehicle yard.

The control unit also is configured to receive, from off-board the first vehicle, an updated time of entry into the vehicle yard for the approaching vehicle and to change a speed of the first vehicle in response to the updated time of entry.

In another embodiment, a method includes receiving an updated time of entry into a vehicle yard at a first vehicle that is moving along a route of a transportation network that includes the vehicle yard and changing a speed of the first vehicle in response to the updated time of entry. The updated time is received from off-board the first vehicle.

In another embodiment, another system includes a monitoring module and a scheduling module. The monitoring module is configured to track a capacity of a vehicle yard in a transportation network to receive vehicles for layover in the vehicle yard over time. The scheduling module is configured to determine an updated time of entry for a first vehicle to enter the vehicle yard based on the capacity of the vehicle yard at the updated time of entry. The scheduling module is configured to communicate the updated time of entry to the first vehicle so that the first vehicle can change speed as the first vehicle moves toward the vehicle yard.

In another embodiment, another method includes tracking a capacity of a vehicle yard to receive vehicles over time, determining an updated time of entry for a first vehicle to enter the vehicle yard based on the capacity of the vehicle yard at the updated time of entry, and communicating the updated time of entry to the first vehicle so that the first vehicle can change speed as the first vehicle moves toward the vehicle yard.

In another embodiment, another system includes a monitoring module and a scheduling module. The monitoring module is configured to track a capacity of a vehicle yard to receive plural vehicles for layover in the vehicle yard over time. The vehicle yard is part of a transportation network having plural routes over which the plural vehicles may travel. The monitoring module is further configured to monitor movement of a first vehicle and at least one second vehicle of the plural vehicles in the transportation network. The scheduling module is configured to determine an updated time of entry for the first vehicle to enter the vehicle yard based on the capacity of the vehicle yard at the updated time of entry. The scheduling module is further configured to designate one or more scheduled waypoints between a current location of the first vehicle and the vehicle yard based on the updated time of entry and the movement of the first and second vehicles. Each of the one or more scheduled waypoints being defined by a location of the waypoint and a scheduled time of arrival of the first vehicle at the waypoint. The one or more scheduled waypoints are designated such that movement of the first vehicle to arrive at the one or more scheduled waypoints as scheduled and enter the vehicle yard at the updated time of entry meets one or more criteria in regards to movement of the at least one second vehicle. The scheduling module also is configured to communicate the updated time of entry and the one or more scheduled waypoints to the first vehicle for the first vehicle to change its speed to meet the scheduled waypoints and updated time of entry.

### BRIEF DESCRIPTION OF THE DRAWINGS

The present inventive subject matter will be better understood from reading the following description of non-limiting embodiments, with reference to the attached drawings, wherein below:

FIG. 1 is a schematic diagram of one embodiment of a transportation network;

FIG. 2 is a schematic diagram of one embodiment of the scheduling system and a vehicle shown in FIG. 1;

FIG. 3 is a schematic diagram of a vehicle yard shown in FIG. 1 in accordance with one embodiment;

FIG. 4 is an illustration of one example of a capacity curve of the vehicle yard shown in FIG. 1;

FIG. 5 is a schematic diagram of a portion of the transportation network shown in FIG. 1 in accordance with one embodiment;

FIG. 6 is a schematic diagram of another portion of the transportation network shown in FIG. 1 in accordance with one embodiment;

FIG. 7 is a flowchart of one embodiment of a method for scheduling travel of vehicles in a transportation network; and

FIG. 8 is a schematic illustration of a system according to embodiments of the invention.

### DETAILED DESCRIPTION

One or more embodiments of the inventive subject matter described herein provide systems for coordinating arrival of a vehicle moving toward a vehicle yard with a capacity of the vehicle yard to receive the vehicle. The vehicle may travel to the vehicle yard to be stored at the vehicle yard (e.g., to end a current trip of the vehicle and remain at the vehicle yard), for repair and/or maintenance of the vehicle, to obtain additional fuel, to unload cargo and/or cars off of the vehicle, to load cargo and/or cars onto the vehicle, to sort the vehicle among other vehicles (e.g., to rearrange an order of the vehicles such that the vehicles leave the vehicle yard in a designated order), or the like. The vehicle yard may act as a transportation hub in a transportation network, such as when the vehicle yard is coupled with several routes extending away from the vehicle yard for the vehicles to travel along to reach other destinations. The vehicle yard may be a final destination of a trip of the vehicle, or may be an intermediate stopping off point when the vehicle is traveling to another business destination (e.g., the destination to which the vehicle is contracted to travel).

The vehicle yard may have a capacity to receive vehicles into the vehicle yard. This capacity can be a space limitation on the number of vehicles that can exit off of a main line route into the vehicle yard. As vehicles come and go from the vehicle yard, the capacity of the vehicle yard to accept other vehicles changes. The travel of a vehicle to the vehicle yard can be controlled such that the vehicle arrives at the vehicle yard when the vehicle yard has sufficient capacity (e.g., space) to receive the vehicle. In one embodiment, the vehicle may be instructed to slow down as the vehicle is traveling toward the vehicle yard so that the vehicle does not arrive at the vehicle yard before the vehicle yard has sufficient capacity to receive the vehicle. The vehicle may be instructed to slow down when doing so does not have a significantly negative impact (e.g., the impact is below a designated threshold) on the flow of traffic in a transportation network formed from interconnected routes, including the route on which the vehicle travels toward the vehicle yard.

While the discussion and figures included herein focus on rail yards as vehicle yards and rail vehicle consists (e.g., trains) as the vehicles, not all embodiments of the inventive subject matter described and claimed herein are limited to rail yards, trains, and railroad tracks. (A consist is a group of vehicles that are mechanically linked to travel together.) The inventive subject matter may apply to other vehicles, such as airplanes, ships, or automobiles. For example, one or more embodiments may apply to control when an airplane arrives at an airport, a shipping facility (e.g., where the airplane drops off and/or receives cargo for delivery elsewhere), a repair or maintenance facility, and the like. Other embodiments may apply to control when a ship arrives at a ship yard or dock, when an automobile arrives at a repair facility, a location having a high density of traffic (e.g., a heavily attended event with several automobiles parked at the event), at a shipping facility (e.g., where the automobile picks up and/or drops off cargo to be delivered elsewhere), and the like.

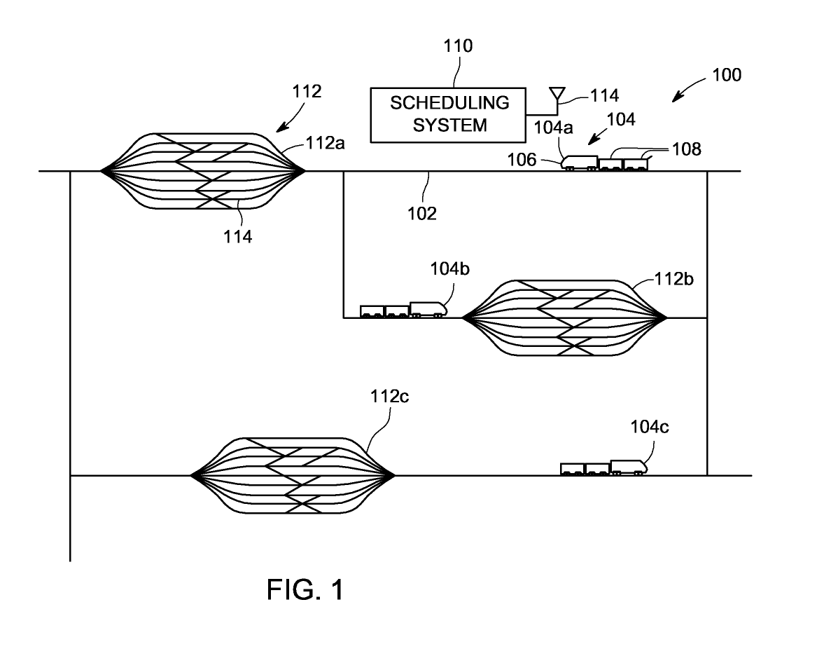

FIG. 1 is a schematic diagram of one embodiment of a transportation network 100. The transportation network 100 includes a plurality of interconnected routes 102, such as railroad tracks, roads, or other paths across which vehicles travel. The routes 102 may be referred to as main line routes when the routes 102 provide paths for the vehicles to travel along in order to travel between a starting location and a destination location (and/or to one or more intermediate locations between the starting location and the destination location). The transportation network 100 may extend over a relatively large area, such as hundreds of square miles or kilometers of land area. While only one transportation network 100 is shown in FIG. 1, one or more other transportation networks 100 may be joined with and accessible to vehicles traveling in the illustrated transportation network 100. For example, one or more of the routes 102 may extend to another transportation network 100 such that vehicles can travel between the transportation networks 100. Different transportation networks 100 may be defined by different geographic boundaries, such as different towns, cities, counties, states, groups of states, countries, continents, and the like. The number of routes 102 shown in FIG. 1 is meant to be illustrative and not limiting on embodiments of the described subject matter. Moreover, while one or more embodiments described herein relate to a transportation network formed from railroad tracks, not all embodiments are so limited. One or more embodiments may relate to transportation networks in which vehicles other than rail vehicles travel, such as paths taken by airplanes, roads or highways traveled by automobiles, water-borne shipping paths taken by ships, and the like.

Several vehicles 104 travel along the routes 102 in the transportation network 100. The vehicles 104 may concurrently travel in the transportation network 100 along the same or different routes 102. Travel of one or more vehicles 104 may be constrained to travel within the transportation network 100 (referred to herein as “intra-network travel”). Alternatively, one or more of the vehicles 104 may enter the transportation network 100 from another transportation network or leave the transportation network 100 to travel into another transportation network (referred to herein as “inter-network travel”). In the illustrated embodiment, the vehicles 104 are shown and described herein as rail vehicles or rail vehicle consists. However, one or more other embodiments may relate to vehicles other than rail vehicles or rail vehicle consists. The vehicles 104 are individually referred to by the reference numbers 104a, 104b, and 104c. While three vehicles 104 are shown in FIG. 1, alternatively, a different number of vehicles 104 may be concurrently traveling in the transportation network 100.

A vehicle 104 may include a group of powered units 106 (e.g., locomotives or other vehicles capable of self-propulsion) and/or non-powered units 108 (e.g., cargo cars, passenger cars, or other vehicles incapable of self-propulsion) that are mechanically coupled or linked together to travel along the routes 102, i.e., a consist. The routes 102 are interconnected to permit the vehicles 104 to travel over various combinations of the routes 102 to move from a starting location to a destination location.

In one embodiment, the vehicles 104 travel along the routes 102 according to a movement plan of the transportation network 100. The movement plan coordinates movement of the vehicles 104 in the transportation network 100 and can include schedules for the vehicles 104. For example, the movement plan may include schedules for the vehicles 104 to move from one or more different starting locations or current locations to one or more different destination locations. The schedules may dictate the destination location and a scheduled arrival time for a vehicle 104 to reach the destination location.

The movement plan may be determined by a scheduling system 110. As shown in FIG. 1, the scheduling system 110 can be disposed off-board (e.g., outside) of the vehicles 104. For example, the scheduling system 110 may be disposed at a central dispatch office for a railroad company. The scheduling system 110 can create and communicate the schedules to the vehicles 104. The scheduling system 110 can include a wireless antenna 206 (and associated transceiver equipment), such as a radio frequency (RF) or cellular antenna, that wirelessly transmits the schedules to the vehicles 104. For example, the scheduling system 110 may transmit destination locations and associated arrival times to the vehicles 104.

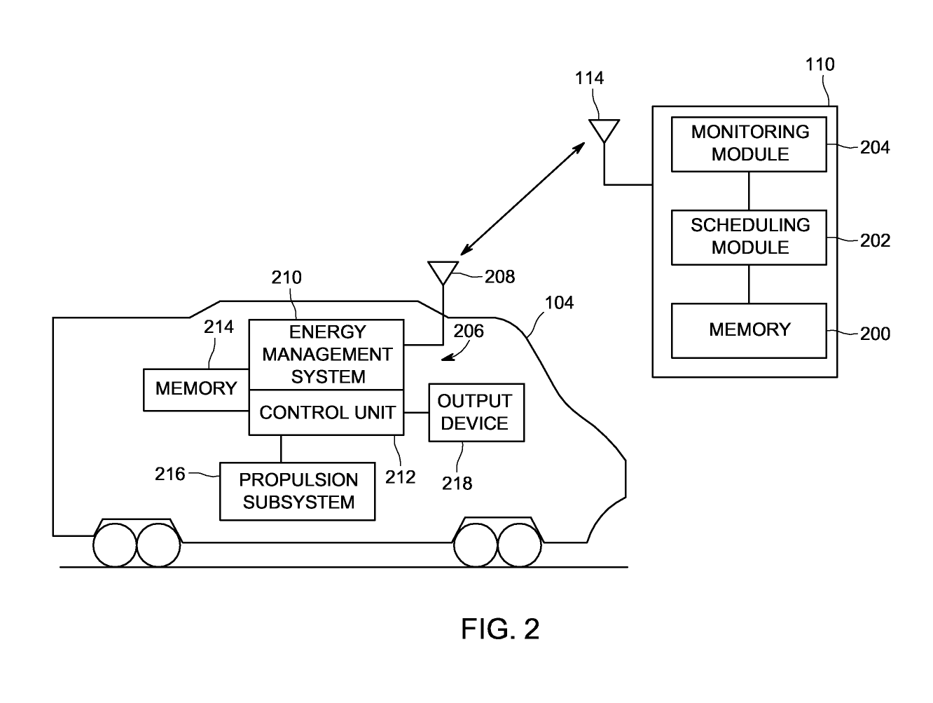

The vehicles 104 include control systems 206 (shown in FIG. 2) disposed on-board the vehicles 104. The control systems receive the schedules from the scheduling system 110 and generate control signals that may be used to control propulsion of the vehicles 104 through the transportation network 100. For example, the vehicles 104 may include wireless antennas (and associated transceiver equipment), such as RF or cellular antennas, that receive the schedules from the scheduling system 110. The control systems on the vehicles 104 examine the schedules, such as by determining the scheduled destination location and scheduled arrival time for the respective vehicle 104, and generate control signals based on the schedule. The control signals may be used to automatically control tractive efforts and/or braking efforts of the vehicle 104 such that the vehicle 104 self-propels along the routes 102 to the destination location. For example, the control system of a vehicle 104 may be operatively coupled with a propulsion subsystem 216 (shown in FIG. 2) of the vehicle 104. The propulsion subsystem may include motors (such as traction motors), engines, brakes (such as air brakes and/or regenerative brakes), and the like, that generate tractive energy to propel the vehicle 104 and/or slow movement of the vehicle 104. The control signals may automatically control the propulsion subsystem, such as by automatically changing throttle settings and/or brake settings of the propulsion subsystem. Alternatively, the control signals may be used to prompt an operator of the vehicle 104 to manually control the tractive efforts and/or braking efforts of the vehicle 104. For example, the control system may include an output device, such as a computer monitor, touchscreen, acoustic speaker, or the like, that generates visual and/or audible instructions based on the control signals. The instructions may direct the operator to manually change throttle settings and/or brake settings of the propulsion subsystem.

The control system of a vehicle 104 may form a trip plan for a trip of the vehicle 104 to travel to a scheduled destination location at a scheduled arrival time. The trip plan may include throttle settings, brake settings, designated speeds, or the like, of the vehicle 104 for various sections of the trip of the vehicle 104. For example, the trip plan can include one or more velocity curves that designate various speeds of the vehicle 104 along various sections of the routes 102. The trip plan can be formed based on a trip profile associated with an upcoming trip of a vehicle 104. The trip profile can include information related to the vehicle 104, the routes 102 over which the vehicle 104 will traverse during the upcoming trip, and/or other information. The information related to the vehicle 104 can include the type of vehicle 104, the tractive energy generated by powered units 106 in the vehicle 104, the weight or mass of the vehicle 104 and/or cargo being carried by the vehicle 104, the length and/or other size of the vehicle 104 (e.g., how many powered and non-powered units 106, 108 are mechanically coupled with each other in the vehicle 104), and the like. The information related to the route 102 can include the curvature, grade (e.g., inclination), existence of ongoing repairs, speed limits, and the like, for one or more sections of the route 102. The other information can include information related to conditions that impact how much fuel the vehicles 104 consume while traveling, such as the air pressure, temperature, humidity, and the like. The control system of a vehicle 104 may form the control signals to control tractive efforts and/or braking efforts of the vehicle 104 based on the trip plan.

In one embodiment, the trip plan is formed by the control system 206 (shown in FIG. 2) of the vehicle 104 to reduce an amount of fuel that is consumed by the vehicle 104 as the vehicle 104 travels to a destination location associated with a schedule that is received by the vehicle 104. The control system may create a trip plan having throttle settings, brake settings, designated speeds, or the like, that propels the vehicle 104 to the scheduled destination location in a manner that consumes less fuel than if the vehicle 104 traveled to the scheduled destination location in another manlier. As one example, the vehicle 104 may consume less fuel in traveling to the destination location according to the trip plan than if the vehicle 104 traveled to the destination location while traveling at another predetermined speed, such as the maximum allowable speed of the routes 102 (which may be referred to as “track speed”).

The transportation network 100 includes one or more vehicle yards 112. The vehicle yards 112 are individually referred to by the reference numbers 112a, 112b, 112c. While three vehicle yards 112 are shown, alternatively, the transportation network 100 may include a different number of vehicle yards 112. The vehicle yards 112 include several interconnected routes 206 that are located relatively close to each other. For example, the routes 206 in the vehicle yards 112 may be closer together (e.g., less than 10, 20, or 30 feet or meters between nearby routes 206) than the routes 102 outside of the vehicle yards 112 (e.g., more than several miles or kilometers between nearby routes 102). The vehicle yards 112 are located along the routes 102 in order to provide services to the vehicles 104, such as to repair or maintain the vehicles 104, re-order the sequence of vehicles 104 traveling along the routes 102 from the vehicle yard 112, store one or more vehicles 104, load the vehicles 104 with additional cargo, unload cargo from the vehicles 104, add powered and/or non-powered units 106, 108 to the vehicles 104, remove powered and/or non-powered units 106, 108 to the vehicles 104, and the like. In one embodiment, the vehicle yards 112 are not used as routes to travel from a starting location to a destination location. For example, the vehicle yards 112 may not be main line routes along which the vehicles 104 travel from a starting location to a destination location. Instead, the vehicle yards 112 may be connected with the routes 102 to allow the vehicles 104 to get off of the main line routes 102 for services described above.

The vehicle yards 112 may have a capacity to receive the vehicles 104 into the vehicle yards 112. The capacity may represent an amount of available space on one or more of the routes 114 in the vehicle yards 112 for the vehicles 104 to be positioned, stored, repaired, and the like (e.g., to stop and remain in place). As vehicles 104 enter into and exit from the vehicle yards 112, the capacity of the vehicle yards 112 to receive other vehicles 104 into the vehicle yards 112 may change. As a result, the capacity of the vehicle yards 112 may be a time-variant parameter that can change as time passes. For example, with respect to trains as vehicles, the capacity of a vehicle yard 112 may change as different sized trains enter and/or leave the vehicle yard 112, and/or are built (e.g., put together to form a train) over time. The trains may be different sizes in that the trains may include different numbers and/or lengths of locomotives and/or other non-powered (e.g., incapable of self-propulsion) cars, such as rail cars that carry cargo and/or passengers. In one embodiment, the size of the vehicle may predominantly be formed from non-powered vehicles, such as rail cars. In another aspect, size may be total length of a train or other rail vehicle consist.

In one embodiment, the control systems 206 (shown in FIG. 2) of the vehicles 104 generate the trip plans to reduce an amount of fuel consumed by the vehicles 104. The control systems also may create and/or modify the trip plans to account for the capacity of a vehicle yard 112 to receive the vehicles 104 at a time when the vehicles 104 will arrive at the vehicle yard 112. For example, a control system may modify a trip plan of a vehicle 104 to cause the vehicle 104 to arrive at a vehicle yard 112 later than previously scheduled so that the vehicle 104 arrives at the vehicle yard 112 when the vehicle yard 112 has capacity to receive the vehicle 104. Otherwise, the vehicle 104 may travel to the vehicle yard 112 according to the trip plan and be forced to sit and idle outside of the vehicle yard 112 until sufficient space becomes available in the vehicle yard 112 for the vehicle 104 to be accepted. Such sitting and idling can cause the amount of fuel that is saved by traveling according to the trip plan to be consumed without propelling the vehicle 104 and may be a wasted asset.

FIG. 2 is a schematic diagram of one embodiment of the scheduling system 110 and the vehicle 104. While the scheduling system 110 is shown in FIG. 2 as communicating with a single vehicle 104, in one embodiment, the scheduling system 110 can concurrently communicate with two or more vehicles 104.

The scheduling system 110 includes several modules that perform various operations or functions described herein. As described above, the modules may include hardware and/or software systems that operate to perform one or more functions, such as one or more computer processors and/or one or more sets of instructions. The modules shown in FIG. 2 may represent the hardware (e.g., a computer processor) and/or software (e.g., one or more sets of instructions such as software applications or hard-wired logic) used to perform the functions or operations associated with the modules. A single hardware component (e.g., a single processor) and/or software component may perform the operations or functions of several modules, or multiple hardware components and/or software components may separately perform the operations or functions associated with different modules. The instructions on which the hardware components operate may be stored on a tangible and non-transitory (e.g., not a transient signal) computer readable storage medium, such as a memory 200. The memory 200 may include one or more computer hard drives, flash drives, RAM, ROM, EEPROM, and the like. Alternatively, one or more of the sets of instructions that direct operations of the hardware components may be hard-wired into the logic of the hardware components, such as by being hard-wired logic formed in the hardware of a processor or controller.

The scheduling system 110 includes a scheduling module 202 that creates schedules for the vehicles 104. In one embodiment, the scheduling module 202 controls communication between the scheduling system 110 and the vehicles 104. For example, the scheduling module 202 may be operatively coupled with the antenna 206 to permit the scheduling module 202 to control transmission of data (e.g., schedules) to the vehicles 104 and to receive data (e.g., trip plans, sizes of the vehicles 104, locations of the vehicles 104, and the like) from the vehicles 104. Alternatively, another module or the processor may be operatively coupled with the antenna 206 to control communication with the vehicles 104.

The scheduling module 202 creates schedules for the vehicles 104. The scheduling module 202 can form the movement plan for the transportation network 100 (shown in FIG. 1) that coordinates the schedules of the various vehicles 104 traveling in the transportation network 100. For example, the scheduling module 202 may generate schedules for the vehicles 104 that are based (at least in part) on capacities of the vehicle yards 112 (shown in FIG. 1) to receive the vehicles 104 when the vehicles 104 will arrive at the vehicle yards 112. The scheduling module 202 may delay a scheduled arrival time for a vehicle 104 to arrive at a vehicle yard 112 if doing so does not have a significant negative impact on the flow of traffic in the transportation network 100. For example, the scheduling module 202 may delay an arrival time of a vehicle 104 when delaying the arrival time does not decrease a throughput parameter of the transportation network 100 below a predetermined threshold.

The throughput parameter can represent the flow or movement of the vehicles 104 through the transportation network 100 or a subset of the transportation network 100. In one embodiment, the throughput parameter can indicate how successful the vehicles 104 are in traveling according to the schedule associated with each vehicle 104. For example, the throughput parameter can be a statistical measure of adherence by one or more of the vehicles 104 to the schedules of the vehicles 104 in the movement plan. The term “statistical measure of adherence” can refer to a quantity that is calculated for a vehicle 104 and that indicates how closely the vehicle 104 is following the schedule associated with the vehicle 104. Several statistical measures of adherence to the movement plan may be calculated for the vehicles 104 traveling in the transportation network 100.

In one embodiment, larger throughput parameters represent greater flow of the vehicles 104 through the transportation network 100, such as what may occur when a relatively large percentage of the vehicles 104 adhere to the associated schedules and/or the amount of congestion in the transportation network 100 are relatively low. Conversely, smaller throughput parameters may represent reduced flow of the vehicles 104 through the transportation network 100. The throughput parameter may reduce in value when a lower percentage of the vehicles 104 follow the associated schedules and/or the amount of congestion in the transportation network 100 is relatively large. Examples of how the throughput parameter may be calculated are described below.

The scheduling system 110 includes a monitoring module 204 in the illustrated embodiment. The monitoring module 204 can monitor travel of the vehicles 104 in the transportation network 100 (shown in FIG. 1) and/or capacities of the vehicle yards 112 (shown in FIG. 1) over time. The vehicles 104 may periodically report current positions of the vehicles 104 to the scheduling system 110 (and/or other information such as route and speed) so that the monitoring module 204 can track where the vehicles 104 are located. Alternatively, signals or other sensors disposed alongside the routes 102 (shown in FIG. 1) of the transportation network 100 can periodically report the passing of vehicles 104 by the signals or sensors to the scheduling system 110. The monitoring module 204 receives the locations of the vehicles 104 in order to monitor where the vehicles 104 are in the transportation network 100 over time.

The monitoring module 204 may track the capacities of the vehicle yards 112 (shown in FIG. 1) by monitoring how many vehicles 104 enter and how many vehicles 104 leave each of the vehicle yards 112. For example, if a vehicle yard 112 has a capacity to receive a predetermined length of vehicles, the monitoring module 204 may calculate a length of vehicles 104 currently in the vehicle yard 112 by tracking the total length of vehicles 104 that enter into the vehicle yard 112 and subtracting the total length of vehicles 104 that leave the vehicle yard 112. The difference between the total length of vehicles 104 that the vehicle yard 112 can accept when the vehicle yard 112 is empty and the total length of vehicles 104 currently in the vehicle yard 112 may be the current capacity of the vehicle yard 112 to accept more vehicles 104. In the case of a rail yard, the current capacity may also be a function of the number and respective lengths of the receiving tracks in the rail yard. For example, even if a receiving track is only partially full, it may be deemed as completely full for purposes of not being able to receive a consist that is longer than the free space remaining on the receiving track.

The monitoring module 204 may determine the throughput parameters of the transportation network 100 (shown in FIG. 1) and/or areas of the transportation network 100 that are used by the scheduling module 202. The monitoring module 204 can calculate the throughput parameters based on the schedules of the vehicles 104 and deviations from the schedules by the vehicles 104. For example, in order to determine a statistical measure of adherence to the schedule associated with a vehicle 104, the monitoring module 204 may monitor how closely the vehicle 104 adheres to the schedule as the vehicle 104 travels in the transportation network 100 (shown in FIG. 1). The vehicle 104 may adhere to the schedule of the vehicle 104 by proceeding along a path toward the scheduled destination such that the vehicle 104 will arrive at the scheduled destination at the scheduled arrival time. For example, an estimated time of arrival (ETA) of the vehicle 104 may be calculated as the time that the vehicle 104 will arrive at the scheduled destination if no additional anomalies occur that change the speed at which the vehicle 104 travels. If the ETA is the same as or within a predetermined time window of the scheduled arrival time, then the monitoring module 204 may calculate a large statistical measure of adherence for the vehicle 104. As the ETA differs from the scheduled arrival time (e.g., by occurring after the scheduled arrival time), the statistical measure of adherence may decrease.

Alternatively, the vehicle 104 may adhere to the schedule by arriving at or passing through scheduled waypoints of the schedule at scheduled times that are associated with the waypoints, or within a predetermined time buffer of the scheduled times. As differences between actual times that the vehicle 104 arrives at or passes through the scheduled waypoints and the associated scheduled times of the waypoints increases, the statistical measure of adherence for the vehicle 104 may decrease. Conversely, as these differences decrease, the statistical measure of adherence may increase.

The monitoring module 204 may calculate the statistical measure of adherence as a time difference between the ETA of a vehicle 104 and the scheduled arrival time of the schedule associated with the vehicle 104. Alternatively, the statistical measure of adherence for the vehicle 104 may be a fraction or percentage of the scheduled arrival time. For example, the statistical measure of adherence may be the fraction or percentage that the difference between the ETA and the scheduled arrival time is of the scheduled arrival time. In another example, the statistical measure of adherence may be a number of scheduled waypoints in a schedule of the vehicle 104 that the vehicle 104 arrives at or passes by later than the associated scheduled time or later than a time window after the scheduled time. Alternatively, the statistical measure of adherence may be a sum total, average, median, or other calculation of time differences between the actual times that the vehicle 104 arrives at or passes by scheduled waypoints and the associated scheduled times.

Table 1 below provides examples of statistical measures of adherence of a vehicle 104 to an associated schedule in a movement plan. Table 1 includes four columns and seven rows. Table 1 represents at least a portion of a schedule of the vehicle 104. Several tables may be calculated for different schedules of different vehicles 104 in the movement plan for the transportation network 100 (shown in FIG. 1). The first column provides coordinates of scheduled locations that the vehicle 104 is to pass through or arrive at the corresponding scheduled times shown in the second column. The coordinates may be coordinates that are unique to a transportation network 100 or that are used for several transportation networks (e.g., Global Positioning System coordinates). The numbers used for the coordinates are provided merely as examples. Moreover, information regarding the scheduled location other than coordinates may be used.

TABLE 1

| Scheduled Location | | | |
|---|---|---|---|
| (SL) | Scheduled Time | Actual Time at SL | Difference |
| (123.4, 567.8) | 09:00 | 09:00 | 0 |
| (901.2, 345.6) | 09:30 | 09:33 | (0:03) |
| (789.0, 234.5) | 10:15 | 10:27 | (0:12) |
| (678.9, 345.6) | 10:43 | 10:44 | (0:01) |
| (987.6, 543.2) | 11:02 | 10:58 | 0:04 |
| (109.8, 765.4) | 11:15 | 11:14 | 0:01 |
| (321.0, 987.5) | 11:30 | 11:34 | (0:04) |

The third column includes a list of the actual times that the vehicle 104 arrives at or passes through the associated scheduled location. For example, each row in Table 1 includes the actual time that the vehicle 104 arrives at or passes through the scheduled location listed in the first column for the corresponding row. The fourth column in Table 1 includes a list of differences between the scheduled times in the second column and the actual times in the third column for each scheduled location.

The differences between when the vehicle 104 arrives at or passes through one or more scheduled locations and the time that the vehicle 104 was scheduled to arrive at or pass through the scheduled locations may be used to calculate the statistical measure of adherence to a schedule for the vehicle 104. In one embodiment, the statistical measure of adherence for the vehicle 104 may represent the number or percentage of scheduled locations that the vehicle 104 arrived too early or too late. For example, the monitoring module 204 may count the number of scheduled locations that the vehicle 104 arrives at or passes through outside of a time buffer around the scheduled time. The time buffer can be one to several minutes. By way of example only, if the time buffer is three minutes, then the monitoring module 204 may examine the differences between the scheduled times (in the second column of Table 1) and the actual times (in the third column of Table 1) and count the number of scheduled locations that the vehicle 104 arrived more than three minutes early or more than three minutes late.

Alternatively, the monitoring module 204 may count the number of scheduled locations that the vehicle 104 arrived early or late without regard to a time buffer. With respect to Table 1, the vehicle 104 arrived at four of the scheduled locations within the time buffer of the scheduled times, arrived too late at two of the scheduled locations, and arrived too early at one of the scheduled locations.

The monitoring module 204 may calculate the statistical measure of adherence by the vehicle 104 to the schedule based on the number or percentage of scheduled locations that the vehicle 104 arrived on time (or within the time buffer). In the illustrated embodiment, the monitoring module 204 can calculate that the vehicle 104 adhered to the schedule (e.g., remained on schedule) for 57% of the scheduled locations and that the vehicle 104 did not adhere (e.g., fell behind or ahead of the schedule) for 43% of the scheduled locations.

Alternatively, the monitoring module 204 may calculate the statistical measure of adherence by the vehicle 104 (shown in FIG. 1) to the schedule based on the total or sum of time differences between the scheduled times associated with the scheduled locations and the actual times that the vehicle 104 arrived at or passed through the scheduled locations. With respect to the example shown in Table 1, the monitoring module 204 may sum the time differences shown in the fourth column as the statistical measure of adherence. In the example of Table 1, the statistical measure of adherence is −15 minutes, or a total of 15 minutes behind the schedule of the vehicle 104.

In another embodiment, the monitoring module 204 may calculate the average statistical measure of adherence by comparing the deviation of each vehicle 104 from the average or median statistical measure of adherence of the several vehicles 104 traveling in the transportation network 100 (shown in FIG. 1). For example, the monitoring module 204 may calculate an average or median deviation of the measure of adherence for the vehicles 104 from the average or median statistical measure of adherence of the vehicles 104.

The monitoring module 204 may determine the throughput parameters for the transportation network 100 (shown in FIG. 1), or an area thereof, based on the statistical measures of adherence associated with the vehicles 104. For example, a throughput parameter may be an average, median, or other statistical calculation of the statistical measures of adherence for the vehicles 104 concurrently traveling in the transportation network 100. The throughput parameter may be calculated based on the statistical measures of adherence for all, substantially all, a supermajority, or a majority of the vehicles 104 traveling in the transportation network 100.

The scheduling module 202 creates schedules for the vehicles 104 and transmits the schedules to the control systems 206 of the vehicles 104. In one embodiment, the scheduling module 202 conveys the schedules to the antenna 206, which transmits the schedules to antennas 208 of corresponding vehicles 104. The control systems 206 of the vehicles 104 receive the schedules sent by the scheduling system 110 and generate control signals to control propulsion of the vehicles 104 based on the schedules. In the illustrated embodiment, the control system 206 includes an energy management system 210 and a control unit 212. One or both of the energy management system 210 and the control unit 212 may be embodied in hardware, such as a processor, controller, or other logic-based device, that performs functions or operations based on one or more sets of instructions (e.g., software). The instructions on which the hardware operates may be stored on a tangible and non-transitory (e.g., not a transient signal) computer readable storage medium, such as a memory 214. The memory 214 may include one or more computer hard drives, flash drives, RAM, ROM, EEPROM, and the like. Alternatively, one or more of the sets of instructions that direct operations of the hardware may be hard-wired into the logic of the hardware.

The schedules that are received from the scheduling system 110 are conveyed to the energy management module 210 of the control system 206. In the illustrated embodiment, the energy management module 210 is disposed on-board the vehicle 104. In another embodiment, the energy management module 210 may be disposed off-board the vehicle 104. For example, the energy management module 210 can be disposed in a central dispatch or other office that generates the trip plans for one or more vehicles 104. The energy management module 210 generates a trip plan for the vehicle 104 based on the schedule. As described above, the trip plan may include throttle settings, brake settings, designated speeds, or the like, of the vehicle 104 for various sections of a scheduled trip of the vehicle 104 to the scheduled destination location. The trip plan may be generated to reduce the amount of fuel that is consumed by the vehicle 104 as the vehicle 104 travels to the destination location relative to travel by the vehicle 104 to the destination location when not abiding by the trip plan.

In order to generate the trip plan for the vehicle 104, the energy management module 210 can refer to a trip profile that includes information related to the vehicle 104, information related to the route 102 (shown in FIG. 1) over which the vehicle 104 travels to arrive at the scheduled destination, and/or other information related to travel of the vehicle 104 to the scheduled destination location at the scheduled arrival time. The information related to the vehicle 104 may include information regarding the fuel efficiency of the vehicle 104 (e.g., how much fuel is consumed by the vehicle 104 to traverse different sections of a route 102), the tractive power (e.g., horsepower) of the vehicle 104, the weight or mass of the vehicle 104 and/or cargo, the length and/or other size of the vehicle 104, the location of the powered units 106 (shown in FIG. 1) in the vehicle 104 (e.g., front, middle, back, or the like of a vehicle consist having several mechanically interconnected units 106, 108), or other information. The information related to the route 102 to be traversed by the vehicle 104 can include the shape (e.g., curvature), incline, decline, and the like, of various sections of the route 102, the existence and/or location of known slow orders or damaged sections of the route 102, and the like. Other information can include information that impacts the fuel efficiency of the vehicle 104, such as atmospheric pressure, temperature, and the like.

The trip plan is formulated by the energy management module 210 based on the trip profile. For example, if the trip profile requires the vehicle 104 (shown in FIG. 1) to traverse a steep incline and the trip profile indicates that the vehicle 104 is carrying significantly heavy cargo, then the energy management module 210 may form a trip plan that includes or dictates increased tractive efforts to be provided by the propulsion subsystem 216 of the vehicle 104. Conversely, if the vehicle 104 is carrying a smaller cargo load and/or is to travel down a decline in the route 102 (shown in FIG. 1) based on the trip profile, then the energy management module 210 may form a trip plan that includes or dictates decreased tractive efforts by the propulsion subsystem 216 for that segment of the trip. In one embodiment, the energy management module 210 includes a software application or system such as the Trip Optimizer™ system provided by General Electric Company.

The control system 206 includes a control unit 212 that generates the control signals for controlling operations of the vehicle 104. The control unit 212 may receive the trip plan from the energy management module 214 and generate the control signals that automatically change the tractive efforts and/or braking efforts of the propulsion subsystem 216 based on the trip plan. For example, the control unit 212 may form the control signals to automatically match the speeds of the vehicle 104 with the speeds dictated by the trip plan for various sections of the trip of the vehicle 104 to the scheduled destination location. Alternatively, the control unit 212 may form control signals that are conveyed to an output device 218 disposed on-board the vehicle 104. The output device 216 can visually and/or audibly present instructions to an operator of the vehicle 104 to change the tractive efforts and/or braking efforts of the vehicle 104 based on the control signals. For example, the output device 218 can include a monitor, touchscreen, or other display device that visually presents textual instructions to the operator to increase or decrease the speed of the vehicle 104 to match a designated speed of the trip plan.

As described above, the scheduling module 202 can create and/or modify a schedule of a vehicles 104 so that the vehicle 104 arrives at a vehicle yard 112 (shown in FIG. 1) when the vehicle yard 112 has sufficient capacity to accept the vehicle 104. In doing so, the vehicle 104 may be able to enter the vehicle yard 112 without stopping and sitting outside the vehicle yard 112 until sufficient space in the vehicle yard 112 opens up for the vehicle 104 to enter.

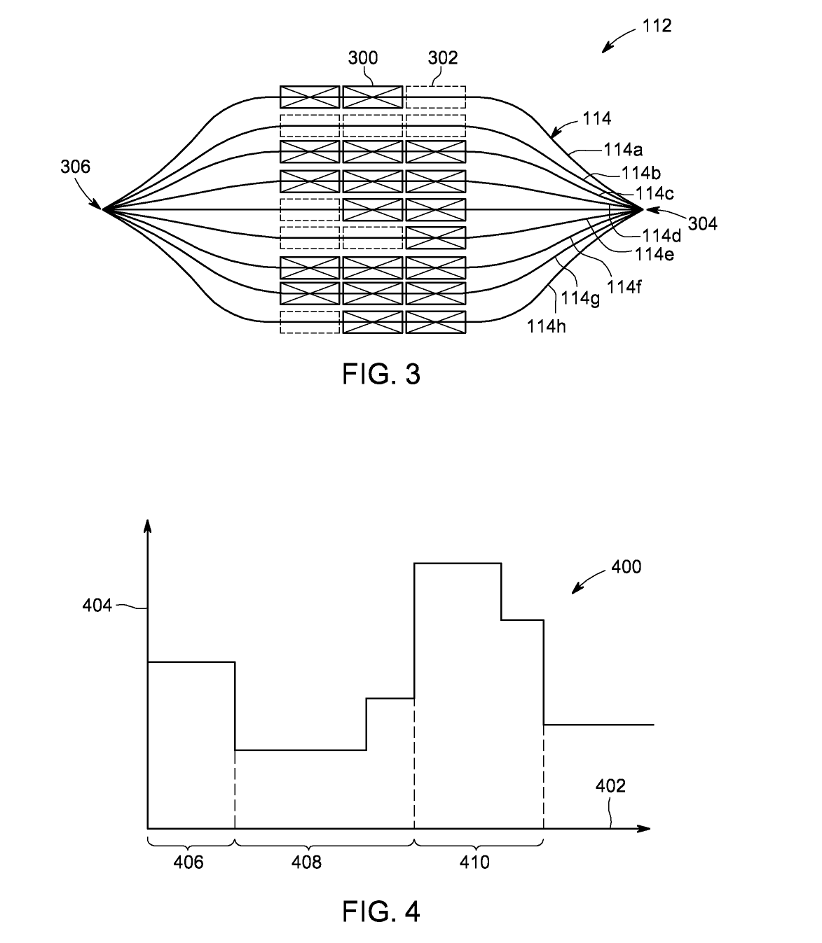

FIG. 3 is a schematic diagram of a vehicle yard 112 in accordance with one embodiment. The vehicle yard 112 is shown with each of the interconnected routes 114 in the vehicle yard 112 having spaces 300, 302 for vehicles 104 (shown in FIG. 1). The routes 114 are individually referred to by the reference numbers 114a, 114b, 114c, and so on. The spaces 300, 302 represent locations where one or more vehicles 104 may park or stop within the vehicle yard 112 for layover, which may include storage, repair, maintenance, loading or unloading of cargo, re-ordering of the vehicles 104, building of one or more vehicles 104 (e.g., connecting powered and/or unpowered vehicles with each other to form a vehicle 104 such as a train), or other services. The vehicles 104 may enter the vehicle yard 112 through a first end 304 that is coupled with one or more of the routes 102 (shown in FIG. 1) of the transportation network 100 (shown in FIG. 1) and stop in one or more of the spaces 300, 302. The vehicles 104 may exit the vehicle yard 112 through the first end 304 and/or a second end 306 that is coupled with one or more of the routes 102. Although not shown in FIG. 3, the routes 114 may be connected with each other between the ends 304, 306 of the vehicle yard 112.

Each of the spaces 300, 302 may represent a designated size of space in the vehicle yard 112 for receiving one or more vehicles 104 (shown in FIG. 1). The spaces 300, 302 may represent an amount of volume, a length, or other measurement of size or space. The spaces 300 are shown with an X through the space to indicate that the space 300 in the vehicle yard 112 is occupied by one or more vehicles 104. The spaces 302 are shown with dashed lines to indicate that the space 302 in the vehicle yard 112 is empty or is otherwise available to receive one or more vehicles 104. The number of vehicles 104 that may be received in one or more of the spaces 302 and/or the number of vehicles 104 occupying the spaces 300 may vary based on the size (e.g., the length) of the vehicles 104. For example, larger or longer vehicles 104 may occupy more than one space 300, 302 while smaller or shorter vehicles 104 may occupy one space 300, 302 or a fraction of a space 300, 302.

The capacity of the vehicle yard 112 to receive additional vehicles 104 can be represented by the amount of available spaces 302 and/or the location of the available spaces 302. In the illustrated embodiment, there are eight available spaces 302. The vehicle yard 112 may be able to accept a corresponding size or length of vehicles 104. For example, on the route 114a, the vehicle yard 112 can accept one or more vehicles 104 that can fit into a single available space 302. On the route 114b, the vehicle yard 112 can accept one or more vehicles 104 that can fit into the three available spaces 302. The routes 114c, 114d, 114f, and 114g cannot accept any additional vehicles 104 as the spaces on these routes 114 are all occupied spaces 300. Other routes 114 have other amounts of available spaces 302.

As vehicles 104 enter into and/or leave the vehicle yard 112, the number or amount of available spaces 302 for receiving additional vehicles 104 may change. For example, if additional vehicles 104 enter into the vehicle yard 112, the number of available spaces 302 may decrease. Conversely, as vehicles 104 leave the vehicle yard 112, the number of available spaces 302 may increase.

FIG. 4 is an illustration of one example of a capacity curve 400 of a vehicle yard 112 (shown in FIG. 1). The capacity curve 400 represents the ability of the vehicle yard 112 to receive vehicles 104 (shown in FIG. 1) into the vehicle yard 112 over time. The capacity curve 400 is shown alongside a horizontal axis 402 representative of time and a vertical axis 404 representative of the capacity of the vehicle yard 112 to receive vehicles 104. The capacity may be expressed in an amount of available spaces 302 (shown in FIG. 3), an amount of available spatial volume, a length, or other measurement of size or numbers of vehicles 104 that can be received into the vehicle yard 112.

As shown in FIG. 4, the capacity of the vehicle yard 112 to receive vehicles 104 can change over time. For example, during a first time period 406, the vehicle yard 112 may have a greater capacity (e.g., more available space) to receive vehicles 104 than a subsequent second time period 408, but a smaller capacity to receive vehicles 104 relative to a subsequent third time period 410. The capacities of the vehicle yard 112 may determined at various times in order to determine when to schedule vehicles 104 to arrive at and enter into the vehicle yard 112.

Returning to the discussion of the scheduling system 110 shown in FIG. 2, the monitoring module 204 can determine when a vehicle yard 112 (shown in FIG. 1) has or will have sufficient capacity to receive a vehicle 104. In one embodiment, the monitoring module 204 can project when the vehicle yard 112 will have sufficient capacity to receive the vehicle 104 based on the schedules of other vehicles 104. For example, the monitoring module 204 can examine the schedules of vehicles 104 traveling in or through the transportation network 100 (shown in FIG. 1). The schedules may indicate which vehicles 104 are scheduled to travel to a vehicle yard 112, when the vehicles 104 are scheduled to enter into the vehicle yard 112, and/or how long the vehicles 104 are scheduled to be in the vehicle yard 112. Based on this information, the monitoring module 204 can estimate a projected or expected capacity of the vehicle yard 112 at one or more times in the future.

Alternatively, the monitoring module 204 may predict the capacity of the vehicle yard 112 (shown in FIG. 1) based on a trend of previous capacities of the vehicle yard 112. For example, the monitoring module 204 can monitor the capacity of the vehicle yard 112 in real time. By “real time,” it is meant that the monitoring module 204 may calculate the capacity of the vehicle yard 112 and change the calculated capacity as vehicles 104 enter into and/or leave the vehicle yard 112. For example, after calculating the capacity of the vehicle yard 112, the monitoring module 204 may add to the capacity when one or more vehicles 104 leave the vehicle yard 112 and/or subtract from the capacity when one or more vehicles 104 enter into the vehicle yard 112. The monitoring module 204 may generate a history of the capacities of the vehicle yard 112 and identify one or more patterns or trends in the history over time. For example, the monitoring module 204 may determine that the vehicle yard 112 has greater capacities during one or more time windows of one or more days of the week, month, year, or the like. The monitoring module 204 may project the capacities of the vehicle yard 112 based on such a history of the capacities.

The scheduling module 202 creates and/or modifies schedules of vehicles 104 based on the projected or expected capacities of the vehicle yards 112 (shown in FIG. 1). For example, the scheduling module 202 may examine a previously generated schedule for a vehicle 104 to determine when the vehicle 104 is scheduled to arrive and enter into a vehicle yard 112. The scheduled time of entry into the vehicle yard 112 can be referred to as a “scheduled time of entry.” The scheduling module 202 can determine a projected or expected capacity of the vehicle yard 112 to receive the vehicle 112 at the scheduled time of entry. If there is sufficient capacity for the vehicle yard 112 to receive the vehicle 104 at the scheduled time of entry, then the scheduling module 202 may not change the scheduled time of entry. On the other hand, if there is insufficient capacity at the scheduled time of entry, then the scheduling module 202 may determine if the scheduled time of entry should be changed, such as by delaying or advancing the scheduled time of entry. The scheduling module 202 can determine one or more alternate times of entry by projecting the capacities of the vehicle yard 112 at various other times and selecting an updated time of entry for the vehicle 104 based on when the projected capacity of the vehicle yard 112 is large enough to receive the vehicle 104. In one embodiment, the scheduling module 202 delays the scheduled time of entry for a vehicle 104 to a later updated time of entry that corresponds to a time when the projected capacity of the vehicle yard 112 is large enough to receive the size of the vehicle 104.

The scheduling module 202 may modify the time of entry for a vehicle 104 as the vehicle 104 approaches the vehicle yard 112 (shown in FIG. 1). For example, the scheduling module 202 may delay the time of entry for the vehicle 104 as the vehicle 104 travels toward the vehicle yard 112 along one or more of the routes 102 (shown in FIG. 1). The scheduling module 202 may periodically or irregularly (e.g., when prompted by an operator) check on the projected capacity of the vehicle yard 112 to receive the vehicle 104 in order to account for unexpected or unplanned changes in the capacity of the vehicle yard 112 and/or the travel of the vehicle 104. For example, the scheduling module 202 may check on the projected capacity when the vehicle 104 falls behind schedule due to one or more other vehicles 104 interfering with the travel of the vehicle 104 headed toward the vehicle yard 112, slow orders or other temporary low speed limits on the routes 102, damaged sections of the routes 102, mechanical damage or need for repair to the vehicle 104, and the like. If the projected capacity is insufficient for the vehicle 104, then the scheduling module 202 may change the scheduled time of entry while the vehicle 104 is traveling toward the vehicle yard 112.

In one embodiment, the scheduling module 202 transmits the updated time of entry to the control system 206 of the vehicle 104. Alternatively, the scheduling module 202 may transmit an updated schedule for the vehicle 104 that includes the updated time of entry. The control system 206 receives the updated time of entry and may change a time at which the vehicle 104 arrives at and/or enters the vehicle yard 112. For example, the control unit 212 may reduce the speed of the vehicle 104 so that the vehicle 104 arrives at and/or enters the vehicle yard 112 at a later time of entry than a previously scheduled time of entry.

In one embodiment, the updated time of entry is communicated to the energy management system 210. The energy management system 210 can determine an updated trip plan based on the updated tune of entry. For example, the energy management system 210 can modify a previously created trip plan or create a new trip plan (either which can be referred to as an updated trip plan) that is based on arriving and/or entering the vehicle yard 112 at the updated tune of entry. The updated trip plan can include tractive efforts, braking efforts, speeds, or the like, for different sections of the trip of the vehicle 104 to the vehicle yard 112 such that the vehicle 114 arrives at and/or enters the vehicle yard 112 at the updated time of entry. The updated trip plan can be used by the control unit 212 to generate control signals that are used to control the propulsion subsystem 216 of the vehicle 104, as described above. As a result, the vehicle 104 may travel to the vehicle yard 112 using an updated trip plan that causes the vehicle 104 to arrive at the vehicle yard 112 when the vehicle yard 112 has capacity to receive the vehicle 104, whereby the vehicle 104 consumes less fuel than if the vehicle 104 were to travel to the vehicle yard 112 and arrive at the updated time of entry according to a different trip plan.

The scheduling module 202 may send the updated time of entry to the vehicle 104 when doing so will not result in one or more throughput parameters of the transportation network 100 (shown in FIG. 1) falling below a predetermined threshold, such as a non-zero threshold. That is, the scheduling module will only send the updated time of entry to the vehicle if the vehicle changing speed to arrive at the vehicle yard at the updated time would not result in a throughput parameter falling below a predetermined threshold. For example, the scheduling module 202 may not send the updated time of entry to the vehicle 104 when sending the updated time of entry to the vehicle 104 will cause the vehicle 104 to change a trip plan of the vehicle 104 that results in an increase, or a significant increase, in traffic congestion in the transportation network 100.

In one embodiment, the scheduling module 202 may generate several different sets of potential schedules for the vehicles 104 (shown in FIG. 1), with at least one of the potential schedules including an updated time of entry for one or more of the vehicles 104 to arrive at the vehicle yard 112. The monitoring module 204 can simulate travel of the vehicles 104 according to the potential schedules in each of the sets and calculate simulated throughput parameters associated with the different sets of the schedules. The monitoring module 204 can compare the simulated throughput parameters of the different sets and, based on the comparison, select one of the sets of schedules to send to the vehicles 104 for use in traveling in the transportation network 100 (shown in FIG. 1). For example, the scheduling module 206 may select the set of schedules having the largest throughput parameter, or a throughput parameter that is larger than one or more other throughput parameters associated with one or more other sets of schedules, and send the selected set of schedules to the vehicles 104, including the schedule having the updated time of entry into the vehicle yard 112.

Alternatively, the scheduling module 202 may generate a set of schedules with at least one schedule including the updated time of entry into the vehicle yard 112 and the monitoring module 204 can simulate travel of the vehicles 104 in the transportation network 100 according to the set of schedules. The monitoring module 204 can calculate a simulated throughput parameter for the set. If the simulated throughput parameter of the set exceeds a predesignated threshold, such as a non-zero threshold, then the scheduling module 202 may select that set of schedules to send to the vehicles 104, including the set having the updated time of entry into the vehicle yard 112. If the simulated throughput parameter does not exceed the threshold, then the scheduling module 202 may generate another, different set of schedules and calculate another simulated throughput parameter. The scheduling module 202 may continue generating sets of schedules and simulating throughput parameters until a simulated throughput parameter of a set exceeds the threshold. If no simulated throughput parameter exceeds the threshold, then the scheduling module 206 may select the set of schedules having a simulated throughput parameter that is larger than the other simulated throughput parameters or the set having a simulated throughput parameter that is greater than the simulated throughput parameter of one or more other sets of schedules.

In another embodiment, the scheduling module 202 may change the time of entry for a vehicle 104 to enter into the vehicle yard 112 based on a confidence parameter. The confidence parameter may represent a probability that changing the time of entry for one or more vehicles 104 will not negatively impact one or more throughput parameters of the transportation network 100 (shown in FIG. 1). For example, the confidence parameter may be calculated as a probability that changing the time of entry for one or more vehicles 104 will not decrease the flow of travel in the transportation network and/or increase traffic congestion in the transportation network 100. If the confidence parameter is sufficiently high, such as by being greater than a predetermined threshold, the scheduling module 202 can change the time of entry of one or more vehicles 104 to enter one or more vehicle yards 112. Such a confidence parameter can indicate that modifying the time of entry (e.g., by delaying the time of entry) is unlikely to negatively impact the throughput parameter of the transportation network 100. Conversely, if the confidence parameter is too low, such as by not exceeding the predetermined threshold, then the confidence parameter can indicate that modifying the previously scheduled time of entry for one or more vehicles 104 may negatively impact the throughput parameter, such as by decreasing the throughput parameter and increasing congestion (e.g., causing more vehicles 104 to fall behind schedule) in the transportation network 100. The monitoring module 204 may determine the confidence parameter in one embodiment. Alternatively, the scheduling module 202 or another module or component may calculate the confidence parameter.

In one embodiment, the confidence parameter is based on a closing distance between the vehicle 104 whose time of entry may be changed and the location of the vehicle yard 112. The “closing distance” means a distance between a location of the vehicle 104 and the vehicle yard 112. If the confidence parameter is calculated at the same time that the vehicle 104 is traveling toward the vehicle yard 112, then the closing distance may represent the distance between a current or last detected location of the vehicle 104 (e.g., as determined by a Global Positioning System receiver of the vehicle 104 or as otherwise input into the scheduling system 110) and the location of the vehicle yard 112. The confidence parameter may be inversely related to the closing distance. For example, the confidence parameter may be smaller for a larger closing distance (e.g., the vehicle 104 is farther from the vehicle yard 112) and the confidence parameter may increase as the closing distance decreases (e.g., as the vehicle 104 moves toward the vehicle yard 112). The confidence parameter may be inversely related to the closing distance because, as the vehicle 104 is farther from the vehicle yard 112, there can be a greater possibility or chance that the vehicle 104 has additional scheduled or unscheduled delays in arriving at the vehicle yard 112 and/or that the vehicle 104 will encounter other vehicles 104 and either be delayed by the other vehicles 104 or cause delay in the travel of the other vehicles 104. A scheduled delay may include a scheduled stop of the vehicle 104 and an unscheduled delay may include an unplanned obtrusion blocking travel of the vehicle 104, a change in the movement plan for the vehicle 104, unforeseen damage to the route 102, and the like. A variety of factors may be considered when forming the inverse relationship between the closing distance and the confidence parameter, such as information related to the route 102 (e.g., the grade, curvature, location of damaged portions, and the like), information related to the vehicle 104 (e.g., length or other size of the vehicle 104), or other information.

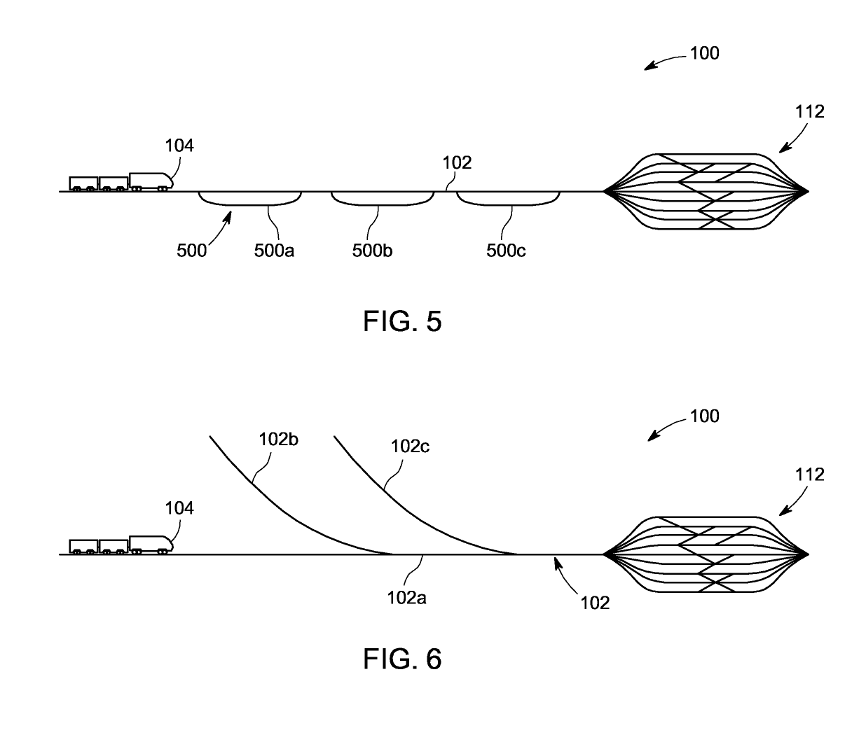

FIG. 5 is a schematic diagram of a portion of the transportation network 100 in accordance with one embodiment. The illustrated portion of the transportation network 100 includes a route 102, such as a main line route, with several siding route sections 500 connected with the route 102. A siding route section 500 may include a section of a track, road, or other path that is connected with the route 102 and that provides an auxiliary path for a vehicle 104 to pull off of the route 102. For example, a first vehicle 104 may pull off the main line route 102 and onto a siding route section 500 to allow a second vehicle 104 traveling on the same main line route 102 in the same or opposite direction to pass the first vehicle 104 on the main line route 102. In the illustrated embodiment, there are three siding route sections 500 disposed between the vehicle 104 and the vehicle yard 112. Alternatively, there may be a different number of siding route sections 500. The siding route sections 500 are individually referred to by the reference numbers 500a, 500b, and 500c.

The confidence parameter may have a value that is based on the number of siding route sections 500 between the vehicle 104 and the vehicle yard 112. For example, with respect to the embodiment shown in FIG. 5, there are three siding route sections 500 between the vehicle 104 and the vehicle yard 112. The confidence parameter calculated for changing the time of entry for the vehicle 104 to enter the vehicle yard 112 may increase if more than three siding route sections 500 are disposed between the vehicle 104 and the vehicle yard 112 and may decrease if less than three siding route sections 500 are disposed between the vehicle 104 and the vehicle yard 112. The confidence parameter may be related to the number of siding route sections 500 in a linear or non-linear relationship. For example, with respect to a linear relationship, as the number of siding route sections 500 within the closing distance of the vehicle 104 increases, the confidence parameter may increase by a number or constant multiplied by the number of the siding route sections 500. With respect to a non-linear relationship, the confidence parameter may change by different amounts for each incremental change in the number of siding route sections 500 in the closing distance.

The confidence parameter may change based on the number of siding route sections 500 because additional siding route sections 500 can provide locations for the vehicle 104 to pull off of the main line route 102 and get out of the way of other vehicles 104 traveling on the main line route 102. For example, delaying the time of entry for the vehicle 104 can cause the vehicle 104 to travel more slowly toward the vehicle yard 112. As the vehicle 104 slows down, the vehicle 104 may risk impeding the flow of traffic in the transportation network 100 by impeding the travel of other vehicles 104 traveling on, or scheduled to travel on, the same main line route 102. Having siding section routes 500 between the vehicle 104 and the vehicle yard 112 can provide locations for the vehicle 104 to move out of the way of other vehicles 104 to avoid significantly impeding the flow of traffic in the transportation network 100 while allowing the vehicle 104 to arrive at the vehicle yard 112 at the updated time of entry.

FIG. 6 is a schematic diagram of another portion of the transportation network 100 in accordance with one embodiment. The illustrated portion of the transportation network 100 includes a first route 102, such as a main line route, with several additional routes 102 connected with the first route 102. The different routes 102 are individually referred to by the reference numbers 102a, 102b, and 102c. Although three routes 102 are shown in FIG. 6, alternatively, a different number of routes 102 may be used.

As shown in FIG. 6, the routes 102 intersect each other. In the illustrated embodiment, the second and third routes 102b, 102c converge with the first route 102a such that vehicles 104 traveling on the second and third routes 102b and/or 102c toward the vehicle yard 112 may merge onto the first route 102a from the second and/or third routes 102b, 102c. Conversely, vehicles 104 traveling on the first route 102a away from the vehicle yard 112 may exit the first route 102a onto the second or third route 102b, 102c. In another embodiment, the intersection between two or more of the routes 102 may be configured differently. For example, instead of the route 102b, 102c merging into the route 102a in a left-to-right direction in the view shown in FIG. 6, one or more of the routes 102b, 102c may merge into the route 102a in a right-to-left direction, or may otherwise be coupled with the route 102a.

The confidence parameter may have a value that is based on the number of intersections between the route 102 that a vehicle 104 is traveling on toward a vehicle yard 112 and another route 102 within the closing distance of the vehicle 104 to the vehicle yard 112. For example, the confidence parameter may increase with increasing intersections within the closing distance of the vehicle 104 and may decrease with decreasing intersections within the closing distance. The confidence parameter may be related to the number of intersections in a linear or non-linear relationship. For example, with respect to a linear relationship, as the number of intersections within the closing distance of the vehicle 104 increases, the confidence parameter may increase by a number or constant multiplied by the number of the intersections. With respect to a non-linear relationship, the confidence parameter may increase or decrease by different amounts for each incremental change in the number of intersections in the closing distance. The confidence parameter may change based on the number of intersections because additional intersections can provide locations for other vehicles 104 to interact with the vehicle 104 heading to the vehicle yard 112. For example, as more routes 102 intersect the first route 102 on which the vehicle 104 is traveling, the possibility that other vehicles 104 may enter onto the first route 102 from the intersecting routes 102 increases. As the possibility that other vehicles 104 may enter onto the first route 102a increases, the potential for the travel of the other vehicles 104 to be impeded or slowed down by the vehicle 104 having an updated or delayed time of entry into the vehicle yard 112 may increase. As a result, the confidence parameter may decrease as the number of intersections increases.

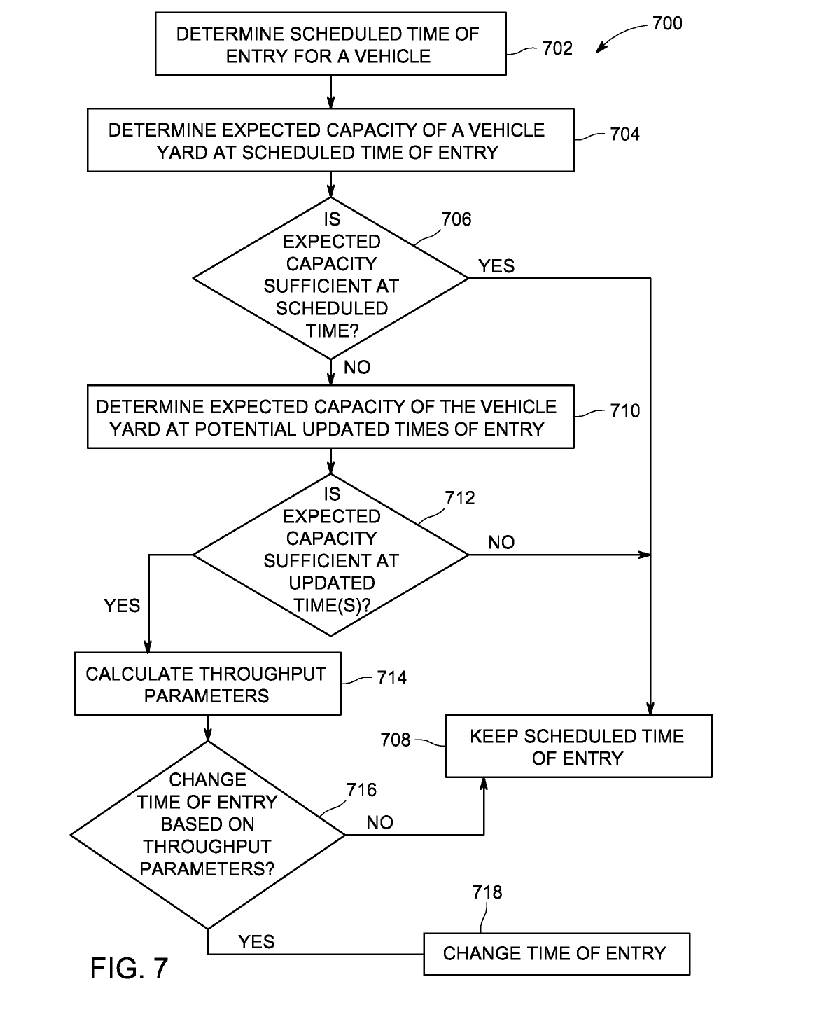

FIG. 7 is a flowchart of one embodiment of a method 700 for scheduling travel of vehicles in a transportation network. The method 700 may be used to schedule when a vehicle 104 (shown in FIG. 1) arrives and/or enters into a vehicle yard 112 (shown in FIG. 1), in accordance with one or more embodiments described above.

At 702, a time of entry that is scheduled for the vehicle 104 is determined. For example, the vehicle 104 may have or be associated with a schedule that dictates travel of the vehicle 104 in or through the transportation network 100 (shown in FIG. 1). The schedule may include directions for the vehicle 104 to travel to a vehicle yards 112 at the time of entry.

At 704, an expected capacity of the vehicle yard 112 to receive the vehicle 104 at the scheduled time of entry is determined. As described above, the expected capacity may be an estimated or calculated capacity of the vehicle yard 112 at the upcoming originally scheduled time of entry.

At 706, a determination is made as to whether the expected capacity of the vehicle yard 112 at the scheduled time of entry is sufficient for the vehicle yard 112 to receive the vehicle 104 at the scheduled time of entry. For example, the expected capacity may be compared to a length or other size of the vehicle 104. If the expected capacity is sufficiently large to receive the vehicle 104 at the scheduled time of entry, then the scheduled time of entry may not need to be changed. For example, the time of entry for the vehicle 104 may not need to be changed because the vehicle yard 112 will be able to accept the vehicle 104. As a result, flow of the method 700 may proceed to 708.

On the other hand, if the expected capacity is not large enough to receive the vehicle 104, then the time of entry may need to be changed (e.g., advanced or delayed) to avoid the vehicle 104 traveling to a location outside of the vehicle yard 112 and waiting (e.g., stopping and idling) outside of the vehicle yard 112 for the vehicle yard 112 to have sufficient capacity to receive the vehicle 104. As a result, the flow of the method 700 flows to 710.

At 710, the expected capacity of the vehicle yard 112 is determined for one or more potential updated times of entry. For example, the expected capacities of the vehicle yard 112 can be calculated at times other than the previously scheduled time of entry.

At 712, a determination is made as to whether the expected capacity of the vehicle yard 112 at one or more of the potential updated times of entry is sufficient for the vehicle yard 112 to receive the vehicle 104 at the potential updated times of entry. If the expected capacity is sufficiently large to receive the vehicle 104 at one or more of the potential updated times of entry, then the previously scheduled time of entry may be changed to the one or more of the potential updated times of entry. For example, the time of entry for the vehicle 104 may be delayed to a later time so that the vehicle yard 112 will have space to receive the vehicle 104 when the vehicle 104 arrives at the vehicle yard 112. As a result, flow of the method 700 may proceed to 714.

On the other hand, if the expected capacity is not large enough to receive the vehicle 104 at the potential updated times of entry, then the previously scheduled time of entry may not be changed (e.g., advanced or delayed). For example, the expected capacities of the vehicle yard 112 may be so low at the potential updated times of entry that changing the previously scheduled time of entry may be unsuccessful in getting the vehicle 104 to the vehicle yard 112 just in time when the vehicle yard 112 has space for the vehicle 104. As a result, flow of the method 700 proceeds to 708.

At 714, one or more throughput parameters of the transportation network 100 are calculated at the potential updated times. For example, estimated throughput parameters may be calculated for the transportation network 100 at the potential updated times of entry that the vehicle yard 112 may have sufficient capacity to receive the vehicle 104. As described above, the throughput parameters can represent the flow of traffic of the vehicles 104 in or through the transportation network 100 at the different potential updated times of entry.

At 716, the one or more throughput parameters associated with the potential updated times of entry at which the vehicle yard 112 has sufficient capacity are examined to determine if any of the throughput parameters are large enough to change the time of entry. For example, the throughput parameters may be compared to one or more thresholds and/or each other to determine if a threshold parameter is sufficiently large. If one or more of the throughput parameters exceed the thresholds and/or are otherwise sufficiently large, then the previously scheduled time of entry may be changed to the updated time of entry associated with one or more of the throughput parameters without significantly decreasing the flow of travel in the transportation network 100. For example, the largest throughput parameter may be selected, or a throughput parameter that is greater than one or more other throughput parameters may be selected, and the previously scheduled time of entry may be changed to the updated time of entry associated with the larger throughput parameter. As a result, flow of the method 700 proceeds to 718.

On the other hand, if the throughput parameters are not sufficiently large (e.g., do not exceed one or more thresholds), then the previously scheduled time of entry may not be able to be changed to the corresponding updated times of entry without negatively impacting the flow of traffic in the transportation network 100. For example, delaying the time of entry may cause the travel of other vehicles 104 in the transportation network 100 to be impeded or otherwise interfered with. If the throughput parameters are not sufficiently large, then flow of the method 700 may proceed to 708.

At 718, the previously scheduled time of entry associated with the throughput parameter and an expected capacity of the vehicle yard 112 that are sufficiently large is changed to the corresponding updated time of entry. As described above, the updated time of entry can be communicated to the vehicle 104 and the control system 206 (shown in FIG. 2) of the vehicle 104 may change the speed of the vehicle 104 based on the updated time of entry. For example, the energy management module 210 may calculate a trip plan or modify a previously created trip plan for the vehicle 104 to arrive at the vehicle yard 112 at the updated time of entry. As described above, the trip plan that is based on the updated time of entry may be followed by the vehicle 104 in order to reduce the amount of fuel consumed by the vehicle 104 in traveling to the vehicle yard 112.

At 708, the previously scheduled time of entry for the vehicle 104 is not changed. For example, if the vehicle yard 112 is expected to have sufficient capacity to receive the vehicle 104 at the previously scheduled time of entry, the vehicle yard 112 will not have sufficient capacity at the potential updated times of entry, and/or the throughput parameters associated with the potential updated times of entry are too low, then the time of entry for the vehicle 104 may not be changed. As a result, the vehicle 104 may continue to travel to the vehicle yard 112 in order to arrive at the previously scheduled time of entry.

In other embodiments, a first vehicle is originally scheduled to arrive at a vehicle yard or other designated location (e.g., destination location) at a first scheduled time. Subsequent to the original schedule being generated, the scheduling system/module receives information indicating that the capacity of the vehicle yard has been or will be reduced such that there will be insufficient capacity for the vehicle yard to receive the first vehicle at the first scheduled time. (It could be the case that the original schedule is generated with the system: (i) having no knowledge of capacity; (ii) knowing there is insufficient capacity at the first scheduled time, but the original schedule is generated anyway due to other constraints; or (iii) at the time the original schedule is generated, information is indicative of sufficient capacity at the first scheduled time, but situations at the vehicle yard change between when the original schedule is generated and the first scheduled time.) Alternatively or additionally, in the case of designated locations other than a vehicle yard, the scheduling system/module may otherwise determine that the first scheduled time is no longer appropriate for the first vehicle to arrive at the designated location, for example, due to newly-arisen conflicts with other vehicles at that time and location. Based on information of the vehicle yard (or other designated location) and/or information relating to other vehicles traveling in the transportation network, the scheduling system identifies a second scheduled time (e.g., earliest time) subsequent to the first scheduled time when the vehicle yard will have sufficient capacity to receive the first vehicle. If slowing of the first vehicle would not decrease a throughput parameter of the transportation network below a predetermined threshold, or if slowing the vehicle would not otherwise interfere with other traffic in the network based on one or more designated criteria, then the scheduling system/module generates and sends an updated schedule to the first vehicle, listing the second scheduled time as when the first vehicle is now scheduled to arrive at the vehicle yard. Responsive to the updated schedule, a control system on the first vehicle may cause the first vehicle to slow, or the control system will otherwise control the first vehicle based on the updated schedule. For example, the control system may generate an updated trip plan based on the updated schedule, for controlling the first vehicle (e.g., automatically controlling the first vehicle) to slow down linearly, or for controlling the vehicle for non-linear and/or piecewise movement. In another embodiment, the updated schedule not only includes an updated, second scheduled time (of designated arrival at the vehicle yard or other location), but also other information of the transportation network, such as information related to other vehicles in the network, and/or objectives to achieve in controlling movement to the vehicle yard.

In another embodiment, a first vehicle is originally scheduled to arrive at a vehicle yard or other designated location at a first scheduled time (e.g., original scheduled time). Subsequent to the original schedule being generated, the scheduling system/module receives information indicating that the capacity of the vehicle yard has been or will be reduced such that there will be insufficient capacity for the vehicle yard to receive the first vehicle at the first scheduled time. Based on information of the vehicle yard and/or information relating to other vehicles traveling in the transportation network, the scheduling system/module identifies a second scheduled time (e.g., earliest time) subsequent to the first scheduled time when the vehicle yard will have sufficient capacity to receive the first vehicle. In addition to identifying the second scheduled time, the scheduling system/module also automatically assesses how revising the velocity profile (e.g., slowing) of the first vehicle might affect the travel of other, second vehicles in the transportation network. If revising the velocity profile in a particular manner would be deemed as excessively interfering with other vehicles based on designated criteria, then the scheduling system/module determines at least one other revised velocity profile, or related information (such as intermediate waypoints that are scheduled in regards to time and location of the first vehicle), that would allow the first vehicle, when correspondingly controlled, to arrive at the vehicle yard (or other designated location) at the second scheduled time but without interfering with other vehicles. Alternatively, the scheduling system/module, as part of the updated schedule provided to the first vehicle, may provide both the second scheduled time and information on other vehicles to the first vehicle; in such a case, a control unit on the first vehicle is configured to determine a velocity profile to arrive at the vehicle yard (or other designated location) at the second scheduled time while avoiding interfering with other, second vehicles.

As an example of such embodiments, a system (e.g., system for controlling movement of vehicles in a transportation network) comprises a control unit configured to be disposed on-board a first vehicle that moves along a route of a transportation network having a vehicle yard or other designated location. The control unit is configured to receive (from off-board the first vehicle) an updated time of entry into the vehicle yard for the first vehicle; more generally, the control unit may be configured to receive an updated time of arrival for the first vehicle at a designated location. (The updated time comprises an updated scheduled time of entry/arrival, e.g., the first vehicle was previously scheduled to arrive at a previous time and is newly scheduled to arrive at the updated time.) The control unit is also configured to change a speed of the first vehicle in response to the updated time of entry/arrival. The control unit is further configured to receive (from off-board the first vehicle) one or more scheduled waypoints between a current location of the first vehicle and the vehicle yard or other designated location. Each of the one or more scheduled waypoints is defined by a location of the waypoint and a scheduled time of arrival of the first vehicle at the waypoint. Alternatively or additionally, the control unit may be further configured to receive information of movement of at least one second vehicle in the transportation network. (The second vehicle is different and distinct from the first vehicle, e.g., the two are not mechanically linked to travel together.) In either or both cases, the control unit is further configured to change the speed of the first vehicle to meet the one or more scheduled waypoints, and/or to change the speed of the first vehicle to meet one or more criteria relating to the movement of the at least one second vehicle and to arrive at the vehicle yard or other designated location at the updated time.

In another embodiment of the system, the control unit is further configured to select a revised velocity profile for the first vehicle, relative to a current velocity profile of the first vehicle, that meets the one or more criteria relating to the movement of the at least one second vehicle and for arrival of the first vehicle at the vehicle yard (or other designated location) at the updated time. The velocity profiles may represent one or more speeds that the first vehicle is to travel at or between various locations. (As an example, the one or more criteria may comprise travel of the first vehicle according to the revised velocity profile not affecting the movement of the at least one second vehicle.) The control unit is further configured to change the speed of the first vehicle according to the revised velocity profile. The revised velocity profile may be selected as part of or in conjunction with a trip plan for the first vehicle generated by an energy management system of the vehicle; thus, characterizations of the control unit selecting a revised profile include an energy management system doing so, i.e., the energy management system may be considered functionally part of the control unit.

In another embodiment of the system, the control unit is further configured to select the revised velocity profile for the first vehicle so that travel of the first vehicle according to the revised velocity profile would result in less fuel used and/or fewer emissions generated than travelling according to the current velocity profile.

As another example of such embodiments, a method (e.g., method for controlling a vehicle) comprises a step of receiving, at a first vehicle that is moving along a route of a transportation network that includes the vehicle yard (or other designated location), an updated time of entry for the first vehicle into the vehicle yard. More generally, the updated time may be an updated time of arrival of the first vehicle at a designated location. (The updated time comprises an updated scheduled time of entry/arrival, e.g., the first vehicle was previously scheduled to arrive at a previous time and is newly scheduled to arrive at the updated time.) The updated time is received from off-board the first vehicle. The method further comprises a step of changing a speed of the first vehicle in response to the updated time of entry (or arrival). The method further comprises a step of receiving (from off-board the first vehicle) one or more scheduled waypoints between a current location of the first vehicle and the vehicle yard or other designated location. Each of the one or more scheduled waypoints is defined by a location of the waypoint and a scheduled time of arrival of the first vehicle at the waypoint. The speed of the first vehicle is changed to meet the one or more scheduled waypoints (meaning the first vehicle is controlled to arrive at the location of each waypoint at the scheduled time of the waypoint) and to arrive at the vehicle yard or other designated location at the updated time.

In another embodiment, a method comprises a step of receiving, at a first vehicle that is moving along a route of a transportation network that includes the vehicle yard (or other designated location), an updated time of entry for the first vehicle into the vehicle yard. (The updated time may otherwise be an updated scheduled time of arrival for the first vehicle at another designated location.) The updated time is received from off-board the first vehicle. The method further comprises a step of receiving, at the first vehicle, information of movement of at least one second vehicle in the transportation network. The speed of the first vehicle is changed to meet one or more criteria relating to the movement of the at least one second vehicle and to arrive at the vehicle yard at the updated time. In another embodiment, the method further comprises a step of selecting a revised velocity profile for the first vehicle, relative to a current velocity profile of the first vehicle, that meets the one or more criteria relating to the movement of the at least one second vehicle and for arrival of the first vehicle at the vehicle yard at the updated time. Here, the speed of the first vehicle is changed according to the revised velocity profile. In other embodiments, the revised velocity profile for the first vehicle is selected so that travel of the first vehicle according to the revised velocity profile would result in less fuel used than travelling according to the current velocity profile.

In another embodiment, a system (e.g., a system for scheduling movement of vehicles in a transportation network) comprises a monitoring module configured to track a capacity of a vehicle yard (or other designated facility or location) in a transportation network to receive vehicles for layover in the vehicle yard over time. The system additionally comprises a scheduling module configured to determine an updated time of entry for (arrival at) a first vehicle to enter the vehicle yard based on the capacity of the vehicle yard at the updated time of entry. The scheduling module is configured to communicate the updated time of entry to the first vehicle so that the first vehicle can change speed as the first vehicle moves toward the vehicle yard. The monitoring module is further configured to monitor movement of at least one second vehicle in the transportation network. The scheduling module is configured to select a revised velocity profile for the first vehicle, relative to a current velocity profile of the first vehicle, that meets one or more criteria relating to the movement of the at least one second vehicle and for arrival of the first vehicle at the vehicle yard at the updated time. Alternatively, in another embodiment, the scheduling module is configured to communicate information of the movement of the at least one second vehicle to the first vehicle for a control unit on the first vehicle to select the revised velocity profile. In other embodiments, the scheduling unit or the control unit is configured to select the revised velocity profile for the first vehicle so that travel of the first vehicle according to the revised velocity profile would result in less fuel used than travelling according to the current velocity profile.

In another embodiment, a system (e.g., a system for scheduling movement of vehicles in a transportation network) comprises a monitoring module configured to monitor movement of a first vehicle and at least one second vehicle in a transportation network having plural routes over which the vehicles may travel. The system additionally comprises a scheduling module configured to determine an updated time of entry for a first vehicle to enter a vehicle yard of the transportation network. (More generally, the scheduling module may be configured determine an updated time of arrival for the first vehicle to arrive at another designated location of the transportation network. Also, the updated time comprises an updated scheduled time of entry/arrival, e.g., the first vehicle was previously scheduled to arrive at a first, previous time and is newly scheduled to arrive at a second, updated time.) The scheduling module is configured to communicate the updated time of entry/arrival to the first vehicle so that the first vehicle can change speed as the first vehicle moves toward the vehicle yard or other designated location. The scheduling module is configured to select a revised velocity profile for the first vehicle, relative to a current velocity profile of the first vehicle, that meets one or more criteria relating to the movement of the at least one second vehicle and for arrival of the first vehicle at the vehicle yard or other designated location at the updated time. Alternatively, in another embodiment, the scheduling module is configured to communicate information of the movement of the at least one second vehicle to the first vehicle for a control unit on the first vehicle to select the revised velocity profile. In other embodiments, the scheduling unit or the control unit is configured to select the revised velocity profile for the first vehicle so that travel of the first vehicle according to the revised velocity profile would result in less fuel used than travelling according to the current velocity profile.

In another embodiment, a system (e.g., a system for scheduling movement of vehicles in a transportation network) comprises a monitoring module configured to monitor movement of a first vehicle and at least one second vehicle in a transportation network having plural routes over which the vehicles may travel. The system further comprises a scheduling module configured to determine a scheduled time of arrival for the first vehicle to arrive at a designated location in the transportation network, e.g., the scheduled time of arrival may be an updated scheduled time of arrival, such as an updated scheduled time of entry into a vehicle yard. The scheduling module is configured to determine one or more scheduled waypoints between a current location of the first vehicle and the designated location. The waypoints are determined based on the scheduled tune of arrival and the movement of the first and second vehicles. Each of the one or more scheduled waypoints is defined by a location of the waypoint and a scheduled time of arrival of the first vehicle at the waypoint. The one or more scheduled waypoints are determined such that movement of the first vehicle to arrive at the one or more scheduled waypoints as scheduled and arrive at the designated location at the scheduled time of arrival meets one or more criteria in regards to movement of the at least one second vehicle. For example, the one or more criteria may comprise movement of the first vehicle as indicated not affecting the movement of the at least one second vehicle. As another example, the one or more criteria may comprise movement of the first vehicle as indicated not affecting the movement of the at least one second vehicle by more than a designated threshold (e.g., not requiring the at least one second vehicle to deviate from a planned speed or time by more than 10%). The scheduling module is configured to communicate the scheduled time of arrival and the one or more scheduled waypoints to the first vehicle for the first vehicle to change its speed to meet (i.e., arrive as scheduled at) the scheduled waypoints and the scheduled time of arrival at the designated location.

In another embodiment, a system (e.g., a system for scheduling movement of vehicles in a transportation network) comprises a monitoring module configured to track a capacity of a vehicle yard to receive plural vehicles for layover in the vehicle yard over time. The vehicle yard is part of a transportation network having plural routes over which the plural vehicles may travel. The monitoring module is further configured to monitor movement of a first vehicle and at least one second vehicle of the plural vehicles in the transportation network. The system further comprises a scheduling module configured to determine an updated time of entry for the first vehicle to enter the vehicle yard based on the capacity of the vehicle yard at the updated time of entry. The scheduling module is further configured to determine one or more scheduled waypoints between a current location of the first vehicle and the vehicle yard based on the updated time of entry and the movement of the first and second vehicles. Each of the one or more scheduled waypoints is defined by a location of the waypoint and a scheduled time of arrival of the first vehicle at the waypoint. The one or more scheduled waypoints are determined such that movement of the first vehicle to meet the scheduled waypoints and enter the vehicle yard at the updated time of entry meets one or more criteria in regards to movement of the at least one second vehicle. The scheduling module is configured to communicate the updated time of entry and one or more scheduled waypoints to the first vehicle for the first vehicle to change its speed to meet the scheduled waypoints and updated time of entry.

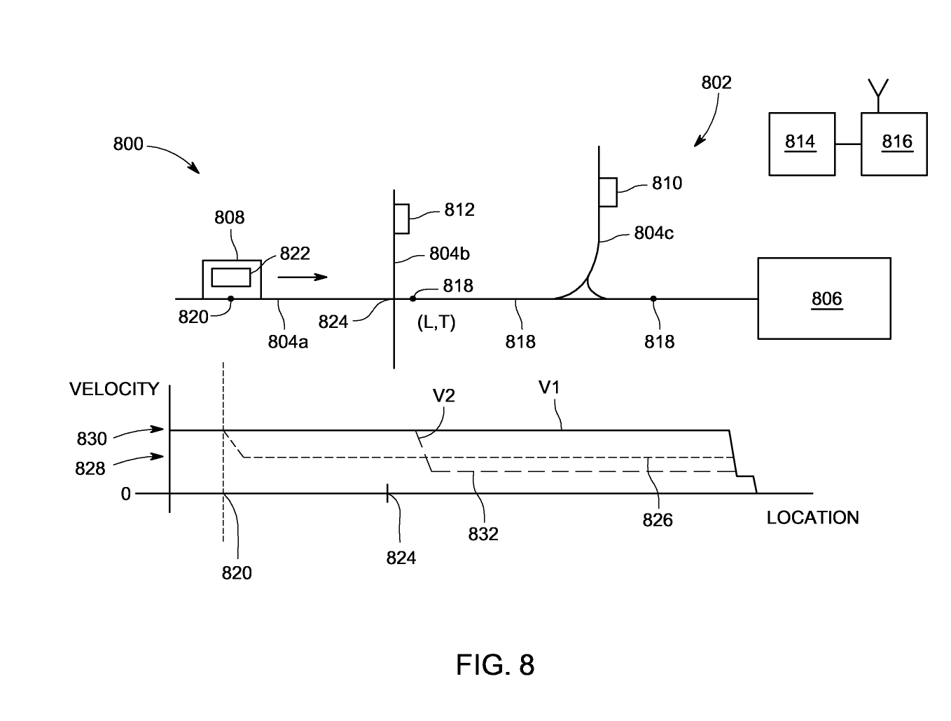

FIG. 8 is illustrative of a transportation control system 800 according to several embodiments of the invention. The system 800 is implemented in the context of a transportation network 802. As indicated, the transportation network 802 includes one or more routes 804a, 804b, 804c, and a vehicle yard or other designated location 806. A first vehicle 808 (e.g., first rail vehicle consist) travels along one of routes, as does one or more second vehicles 810, 812 (e.g., second rail vehicle consist(s)). The system 800 includes a monitoring module 814 and a scheduling module 816, which is operably connected to the monitoring module. The modules 814, 816 may be located off-board any vehicles, such as at a central dispatch office. At least one of the modules includes communication equipment, or an interface with such equipment, for communicating with vehicles in the network. The monitoring module 814 is configured to monitor movement of the first vehicle 808 and at least one second vehicle 810, 812 in the transportation network. The scheduling module 816 is configured to determine a scheduled time of arrival for the first vehicle to arrive at the designated location 806, e.g., the scheduled time of arrival may be an updated scheduled time of arrival, such as an updated scheduled time of entry into a vehicle yard.

In one embodiment, the scheduling module 816 is configured to designate one or more scheduled waypoints 818 between a current location 820 of the first vehicle and the vehicle yard or other designated location 806. The waypoints 818 are designated based on the scheduled time of arrival and the movement of the first and second vehicles 808, 810, 812. Each of the one or more scheduled waypoints is defined by a location “L” of the waypoint and a scheduled time of arrival “T” of the first vehicle at the waypoint. The one or more scheduled waypoints 818 are determined such that movement of the first vehicle 808 to arrive at the one or more scheduled waypoints as scheduled and arrive at the designated location 806 at the scheduled time of arrival meets one or more criteria in regards to movement of the at least one second vehicle 810, 812. For example, as noted above, the one or more criteria may comprise movement of the first vehicle 808 as indicated not affecting the movement of the at least one second vehicle 810, 812. As another example, the one or more criteria may comprise movement of the first vehicle as indicated not affecting the movement of the at least one second vehicle by more than a designated threshold. The scheduling module 816 is configured to communicate the scheduled time of arrival and the one or more scheduled waypoints 818 to the first vehicle 808 for the first vehicle to change its speed to meet (i.e., arrive as scheduled at) the scheduled waypoints and updated time of arrival. Thus, it may be the case that at least one of the scheduled waypoints, for the first vehicle to arrive at the waypoint as scheduled, requires the vehicle to change speed for arrival at the designated location at the scheduled time of arrival without affecting the travel of one or more other vehicles in the network.

In another embodiment of the system 800, the designated location 806 is a vehicle yard, and the monitoring module 814 is configured to track a capacity of the vehicle yard to receive plural vehicles for layover in the vehicle yard over time. The vehicle yard is part of the transportation network 802. The scheduling module 816 is configured to determine an updated time of entry for the first vehicle to enter the vehicle yard (the updated time is an updated scheduled time of entry) based on the capacity of the vehicle yard at the updated time of entry. Scheduled waypoints are designated as described above.

In another embodiment of the system 800, the monitoring module 814 is configured to monitor movement of the first vehicle 808 and the at least one second vehicle 810, 812. The scheduling module 816 is configured to determine an updated time of entry for the first vehicle to enter a vehicle yard of the transportation network, or the scheduling module may otherwise determine a scheduled time of arrival (e.g., updated scheduled time of arrival) for the first vehicle to arrive at another designated location 806 of the transportation network. The scheduling module 816 is configured to communicate the scheduled time of entry/arrival to the first vehicle 808 so that the first vehicle can change speed as the first vehicle moves toward the vehicle yard or other designated location 806. The scheduling module 816 is configured to select a revised velocity profile “V2” for the first vehicle, relative to a current velocity profile “V1” of the first vehicle, that meets one or more criteria relating to the movement of the at least one second vehicle 810, 812 and for arrival of the first vehicle at the vehicle yard or other designated location at the scheduled time (e.g., updated scheduled time). Alternatively, in another embodiment, the scheduling module 816 is configured to communicate information of the movement of the at least one second vehicle 810, 812 to the first vehicle for a control unit 822 on the first vehicle to select the revised velocity profile V2. In other embodiments, the scheduling unit or the control unit is configured to select the revised velocity profile for the first vehicle so that travel of the first vehicle according to the revised velocity profile would result in less fuel used than travelling according to the current velocity profile.

As an example, suppose the first vehicle 808 is originally scheduled to arrive at a vehicle yard or other designated location 806 at a first time T1. The first vehicle 808 travels along a route 804a to the vehicle yard 806 according to a trip plan, which establishes a first velocity profile V1 having: a constant velocity to just outside the vehicle yard, a subsequent deceleration, and a final deceleration to stop at the vehicle yard. Traveling according to the trip plan would have the vehicle clearing a route crossing or intersection 824 at a second time T2, which is before time T1. Later, the scheduling module 816 determines that the vehicle yard will lack sufficient capacity at time T1. The scheduling module 816 identifies the next time T3 (later than T1) when there will be sufficient capacity, or otherwise determines an updated scheduled time for arrival at a designated location. The scheduling module 816 and/or the control unit 822 on board the first vehicle 808 selects a revised velocity profile V2 (revised relative to the current velocity profile V1) for the first vehicle 808, based on the updated scheduled time T3 and on movement of the first vehicle 808 and one or more second vehicles 812 in the network. The revised velocity profile V2 is selected to meet one or more criteria relating to the movement of the at least one second vehicle 810, 812 and for arrival of the first vehicle at the vehicle yard or other designated location at the updated scheduled time T3. The revised velocity profile V2 may be selected by iteratively analyzing one or more possible/potential second velocity profiles of the first vehicle for the first vehicle to arrive at the vehicle yard at the updated scheduled time T3, relative to the vehicle movement, for determining whether the velocity profile(s) meet the one or more designated criteria. For example, for the first vehicle starting at a current location 820 and scheduled to arrive at the vehicle yard 806 at a later time than originally scheduled, a first revised velocity profile 826 for analysis might be the first vehicle 808 decelerating to a lower velocity 828 than its current velocity 830, and traveling at that velocity 828 to the vehicle yard (i.e., over a set route, the simplest control scheme for traveling the same distance over a longer time is a lower constant velocity.) However, traveling at the lower velocity 828 would result in the first vehicle 808 clearing the crossing or intersection 824 at time T4, which is later than time T2, which is the time the first vehicle 808 was originally scheduled to cross the crossing or intersection. The scheduling module or control unit determines what effect this would have on the movement of the second vehicles 801, 812, if any. For example, if one of the second vehicles 812 is scheduled to cross the crossing or intersection 824 around time T4, then the analyzed potential second velocity profile 826 might be deemed as not meeting a designated criterion, as interfering with the second vehicle 812. That is, in this example, the designated criterion for selecting a velocity profile for use in controlling a vehicle 808 (to arrive at a vehicle yard at an updated scheduled time) would be that doing so would not interfere with the scheduled or actual travel of any other vehicles in the network. If no vehicles are scheduled to cross the crossing or intersection 824 around time T4, then the potential second velocity profile 826 is further analyzed by determining whether travel of the first vehicle 808 along the route 804a, as a function of time, would interfere with the scheduled movement of other vehicles 810 along the route 804a. If not, the potential second velocity profile 826 may be selected for use. If so, then other potential second velocity profiles are analyzed, as a function of movement of the first and second vehicles. For example, if the only interaction between a second vehicle 812 and the route 804a between the current time and the updated scheduled time T3 is at time T4 at the crossing or intersection 824, then the scheduling module or control unit may select a second velocity profile based on controlling the first vehicle temporally (time-wise) around time T4, for example, traveling at the original velocity 830 until past the crossing or intersection 824, and then slowing to a velocity 832, which is less than the original velocity 830, for final travel to the yard to arrive at the updated scheduled time T3. Thus, the scheduling module and/or on-board control unit analyzes each potential second velocity profile for interference with other second, vehicles 810, 812 and for meeting other objectives (e.g., reducing fuel use versus other profiles), and selects the one most appropriate according to designated criteria.

In other embodiments, one of the criteria for selecting a revised velocity profile V2 is using less fuel versus controlling the first vehicle 808 to travel according to the first/original velocity profile V1 or other possible revised velocity profiles. For such determinations, an energy management system on board the first vehicle 808 may be configured to select the fuel optimal velocity profile that otherwise meets designated criteria (regarding travel of other vehicles in the network), or an on-board control unit 822 may be configured to analyze projected fuel usage as a function of vehicle/engine type, empirical or otherwise determined fuel use versus vehicle acceleration and velocity curves, or the like.

In other embodiments, in the case when the scheduling system/module determines that the first scheduled time of arrival for a first vehicle at a designated location is no longer appropriate, the scheduling system/module determines plural second/updated scheduled times, and/or an updated scheduled time window for arrival, any of which are suitable for arrival by the first vehicle at the designated location. (For example, in the case of a vehicle yard, whereas there might not be capacity at the first scheduled time for the vehicle yard to receive the first vehicle, there would be such capacity at any of the second/updated scheduled times or updated scheduled time window.) The second/updated scheduled times and/or updated scheduled time window are communicated by the scheduling system/module to the first vehicle. The control unit on the first vehicle is configured to select one of the second/updated scheduled times and/or a time within the updated scheduled time window communicated by the scheduling system/module, which serves as the basis for vehicle control (e.g., as part of a trip plan, selected velocity profile, or the like). The time may be selected based on one or more designated criteria, such as earliest time of arrival, or travelling to arrive at the selected time facilitating lower (or lowest) fuel usage versus other times.

In one embodiment, a system includes a control unit that is configured to be disposed on-board a first vehicle that moves along a route of a transportation network having a vehicle yard. The control unit also is configured to receive, from off-board the first vehicle, an updated time of entry into the vehicle yard for the approaching vehicle and to change a speed of the first vehicle in response to the updated time of entry.

In another aspect, the first vehicle is previously scheduled to enter into the vehicle yard at a previous time and the updated time is subsequent to the previous time. The control unit can be configured to decrease the speed of the approaching vehicle based on the updated time of entry.

In another aspect, the updated time of entry is based on a size of the first vehicle.

In another aspect, the updated time of entry is based on a capacity of the vehicle yard to receive the first vehicle at the updated time of entry.

In another aspect, the vehicle yard is interconnected with one or more other routes in a transportation network and the updated time of entry is based on a throughput parameter of vehicles traveling through the transportation network.

In another aspect, the updated time of entry is based on travel of one or more other vehicles traveling along the route subsequent to the first vehicle.

In another aspect, the updated time of entry is based on a number of one or more siding route sections or divergent route sections joined with the route between a location of the first vehicle and the vehicle yard.

In another aspect, the system also includes an energy management system configured to be disposed on-board the first vehicle. The energy management system also is configured to form a trip plan that dictates tractive efforts of the first vehicle based on a trip profile and to receive the updated time of entry and revise the trip plan based on the updated time of entry to form a revised trip plan. The control unit is configured to control movement of the first vehicle based on the revised trip plan.

In another aspect, the control unit is configured to receive the updated time of entry as the first vehicle is approaching the vehicle yard.

In another aspect, the control unit is further configured to receive from off-board the first vehicle at least one of (a) one or more scheduled waypoints between a current location of the first vehicle and the vehicle yard (with each of the one or more scheduled waypoints being defined by a location of the waypoint and a scheduled time of arrival of the first vehicle at the waypoint) or (b) information of movement of at least one second vehicle in the transportation network. The control unit can be further configured to at least one of: change the speed of the first vehicle to meet the one or more scheduled waypoints and to arrive at the vehicle yard at the updated time, or to change the speed of the first vehicle to meet one or more criteria relating to the movement of the at least one second vehicle and to arrive at the vehicle yard at the updated time.

In another aspect, the control unit is further configured to select a revised velocity profile for the first vehicle, relative to a current velocity profile of the first vehicle, that meets the one or more criteria relating to the movement of the at least one second vehicle and for arrival of the first vehicle at the vehicle yard at the updated time, and to change the speed of the first vehicle according to the revised velocity profile.

In another aspect, the control unit is further configured to select the revised velocity profile for the first vehicle so that travel of the first vehicle according to the revised velocity profile would result in less fuel used than travelling according to the current velocity profile.

In another aspect, the one or more criteria comprises travel of the first vehicle according to the revised velocity profile not affecting the movement of the at least one second vehicle.

In another embodiment, a method includes receiving an updated time of entry into a vehicle yard at a first vehicle that is moving along a route of a transportation network that includes the vehicle yard and changing a speed of the first vehicle in response to the updated time of entry. The updated time is received from off-board the first vehicle.

In another aspect, the first vehicle is previously scheduled to enter into the vehicle yard at a previous time and the updated time is subsequent to the previous time. Changing the speed can include decreasing the speed of the first vehicle based on the updated time of entry.

In another aspect, the updated time of entry is based on a size of the first vehicle.

In another aspect, the updated time of entry is based on a capacity of the vehicle yard to receive the first vehicle at the updated time of entry.

In another aspect, the route and the vehicle yard are interconnected in the transportation network and the updated time of entry is based on a throughput parameter of vehicles traveling through the transportation network.

In another aspect, the updated time of entry is based on travel of one or more other vehicles traveling along the route subsequent to the first vehicle.

In another aspect, the updated time of entry is based on a number of one or more siding route sections or divergent route sections joined with the route between a location of the first vehicle and the vehicle yard.

In another aspect, changing the speed comprises providing the updated time of entry to an energy management system disposed on-board the first vehicle, revising by the energy management system of a trip plan of the first vehicle based on the updated time of entry to form a revised trip plan, and controlling movement of the first vehicle based on the revised trip plan.

In another aspect, the method also includes receiving from off-board the first vehicle one or more scheduled waypoints between a current location of the first vehicle and the vehicle yard. Each of the one or more scheduled waypoints is defined by a location of the waypoint and a scheduled time of arrival of the first vehicle at the waypoint. The speed of the first vehicle is changed to meet the one or more scheduled waypoints and to arrive at the vehicle yard at the updated time.

In another aspect, the method also includes receiving at the first vehicle information of movement of at least one second vehicle in the transportation network. The speed of the first vehicle is changed to meet one or more criteria relating to the movement of the at least one second vehicle and to arrive at the vehicle yard at the updated time.

In another aspect, the method also includes selecting a revised velocity profile for the first vehicle, relative to a current velocity profile of the first vehicle, that meets the one or more criteria relating to the movement of the at least one second vehicle and for arrival of the first vehicle at the vehicle yard at the updated time. The speed of the first vehicle is changed according to the revised velocity profile.

In another aspect, the revised velocity profile for the first vehicle is selected so that travel of the first vehicle according to the revised velocity profile would result in less fuel used than travelling according to the current velocity profile.

In another embodiment, another system includes a monitoring module and a scheduling module. The monitoring module is configured to track a capacity of a vehicle yard in a transportation network to receive vehicles for layover in the vehicle yard over time. The scheduling module is configured to determine an updated time of entry for a first vehicle to enter the vehicle yard based on the capacity of the vehicle yard at the updated time of entry. The scheduling module is configured to communicate the updated time of entry to the first vehicle so that the first vehicle can change speed as the first vehicle moves toward the vehicle yard.

In another aspect, the scheduling module is configured to delay a previously scheduled time of entry of the first vehicle to enter into the vehicle yard to the updated time of entry based on an expected capacity of the vehicle yard to receive the first vehicle at the updated time of entry.

In another aspect, the scheduling module is configured to receive information of a size of the first vehicle and to determine the updated time of entry based on the size of the first vehicle.

In another aspect, the scheduling module is configured to determine the updated tune of entry based on a throughput parameter of the transportation network that is representative of a flow of vehicles through the transportation network.

In another aspect, the scheduling module is configured to communicate the updated time only if the first vehicle changing speed to arrive at the vehicle yard at the updated time would not result in the throughput parameter falling below a predetermined threshold.

In another aspect, the scheduling module is configured to determine the updated time of entry based on travel of one or more other, second vehicles traveling along a route of the first vehicle subsequent to the first vehicle.

In another aspect, the scheduling module is configured to determine the updated time of entry based on a number of one or more siding route sections or divergent route sections joined with a route that the first vehicle is traveling on toward the vehicle yard between a location of the first vehicle and the vehicle yard.

In another aspect, the scheduling module is configured to communicate the updated time of entry to an energy management system disposed on-board the first vehicle and is configured to form a trip plan for controlling the first vehicle.

In another aspect, the scheduling module is configured to determine the updated time of entry as the first vehicle is moving toward the vehicle yard.

In another aspect, the scheduling module is configured to receive information of plural other vehicles in the transportation network that are traveling to the vehicle yard for layover in the vehicle yard, and to determine the capacity of the vehicle yard at the updated time of entry based on the information of the plural other vehicles.

In another aspect, the monitoring module is configured to monitor movement of at least one second vehicle in the transportation network and the scheduling module is configured to one of (a) select a revised velocity profile for the first vehicle, relative to a current velocity profile of the first vehicle, that meets one or more criteria relating to the movement of the at least one second vehicle and for arrival of the first vehicle at the vehicle yard at the updated time or (b) communicate information of the movement of the at least one second vehicle to the first vehicle for a control unit on the first vehicle to select the revised velocity profile.

In another aspect, the scheduling module or the control module is configured to select the revised velocity profile for the first vehicle so that travel of the first vehicle according to the revised velocity profile would result in less fuel used than travelling according to the current velocity profile.

In another aspect, the scheduling module is configured to generate different sets of schedules for the vehicles to travel with at least one of the schedules in the different sets including the updated time of entry. The monitoring module is configured to simulate travel of the vehicles according to the different sets of schedules and to calculate throughput parameters associated with the different sets of schedules.

In another aspect, the scheduling module is configured to communicate at least one of the sets of schedules to the vehicles based on a comparison between the throughput parameters associated with the different sets of schedules.

In another aspect, the scheduling module is configured to communicate the updated time of entry to the first vehicle only when a confidence parameter associated with the updated time of entry exceeds a designated threshold. The confidence parameter is representative of a probability that directing the first vehicle to arrive at the vehicle yard at the updated time of entry will not negatively impact a throughput parameter of the vehicles.

In another embodiment, another method includes tracking a capacity of a vehicle yard to receive vehicles over time, determining an updated time of entry for a first vehicle to enter the vehicle yard based on the capacity of the vehicle yard at the updated time of entry, and communicating the updated time of entry to the first vehicle so that the first vehicle can change speed as the first vehicle moves toward the vehicle yard.

In another aspect, determining the updated time of entry includes delaying a previously scheduled time of entry of the first vehicle to enter into the vehicle yard to the updated time of entry based on an expected capacity of the vehicle yard to receive the first vehicle at the updated time of entry.

In another aspect, tracking the capacity includes monitoring a size of the first vehicle and the updated time of entry is based on the size of the first vehicle.

In another aspect, the first vehicle travels toward the vehicle yard in a transportation network and the updated time of entry is based on a throughput parameter of the transportation network that is representative of a flow of vehicles through the transportation network.

In another aspect, the updated time of entry is based on travel of one or more other vehicles traveling along the route subsequent to the first vehicle.

In another aspect, the updated time of entry is based on a number of one or more siding route sections or divergent route sections joined with a route that the first vehicle is traveling on toward the vehicle yard between a location of the first vehicle and the vehicle yard.

In another aspect, communicating the updated time of entry includes transmitting the updated time of entry to an energy management system disposed on-board the first vehicle for use of the updated time of entry by the energy management system to form a trip plan for controlling the first vehicle.

In another aspect, determining the updated time of entry and communicating the updated time of entry occur as the first vehicle is moving toward the vehicle yard.

In another embodiment, another system includes a monitoring module and a scheduling module. The monitoring module is configured to track a capacity of a vehicle yard to receive plural vehicles for layover in the vehicle yard over time. The vehicle yard is part of a transportation network having plural routes over which the plural vehicles may travel. The monitoring module is further configured to monitor movement of a first vehicle and at least one second vehicle of the plural vehicles in the transportation network. The scheduling module is configured to determine an updated time of entry for the first vehicle to enter the vehicle yard based on the capacity of the vehicle yard at the updated time of entry. The scheduling module is further configured to designate one or more scheduled waypoints between a current location of the first vehicle and the vehicle yard based on the updated time of entry and the movement of the first and second vehicles. Each of the one or more scheduled waypoints being defined by a location of the waypoint and a scheduled time of arrival of the first vehicle at the waypoint. The one or more scheduled waypoints are designated such that movement of the first vehicle to arrive at the one or more scheduled waypoints as scheduled and enter the vehicle yard at the updated time of entry meets one or more criteria in regards to movement of the at least one second vehicle. The scheduling module also is configured to communicate the updated time of entry and the one or more scheduled waypoints to the first vehicle for the first vehicle to change its speed to meet the scheduled waypoints and updated time of entry.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §108, sixth paragraph, unless and until such claim limitations expressly use the phrase “means for” followed by a statement of function void of further structure.

This written description uses examples to disclose several embodiments of the inventive subject matter, including the best mode, and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “comprises,” “including,” “includes,” “having,” or “has” an element or a plurality of elements having a particular property may include additional such elements not having that property.

What is claimed is:

1. A system comprising:
a control unit configured to be disposed on-board a first vehicle that moves along a route of a transportation network having a vehicle yard, the control unit configured to receive from off-board the first vehicle an updated time of entry into the vehicle yard for the first vehicle; and
wherein the control unit is configured to change a speed of the first vehicle in response to the updated time of entry.

2. The system of claim 1, wherein the first vehicle is previously scheduled to enter into the vehicle yard at a previous time and the updated time is subsequent to the previous time, and the control unit is configured to decrease the speed of the first vehicle based on the updated time of entry.

3. The system of claim 1, further comprising an energy management system configured to be disposed on-board the first vehicle and to form a trip plan that dictates tractive efforts of the first vehicle, the energy management system configured to receive the updated time of entry and revise the trip plan based on the updated time of entry to form a revised trip plan,
wherein the control unit is configured to control movement of the first vehicle based on the revised trip plan.

4. The system of claim 1, wherein the control unit is configured to receive the updated time of entry as the first vehicle is approaching the vehicle yard.

5. The system of claim 1, wherein the control unit is further configured to receive from off-board the first vehicle at least one of:
one or more scheduled waypoints between a current location of the first vehicle and the vehicle yard, each of the one or more scheduled waypoints being defined by a location of the waypoint and a scheduled time of arrival of the first vehicle at the waypoint; or
information of movement of at least one second vehicle in the transportation network;
and wherein the control unit is further configured to at least one of: change the speed of the first vehicle to meet the one or more scheduled waypoints; and to arrive at the vehicle yard at the updated time, or to change the speed of the first vehicle to meet one or more criteria relating to the movement of the at least one second vehicle and to arrive at the vehicle yard at the updated time.

6. The system of claim 5, wherein the control unit is further configured to select a revised velocity profile for the first vehicle, relative to a current velocity profile of the first vehicle, that meets the one or more criteria relating to the movement of the at least one second vehicle and for arrival of the first vehicle at the vehicle yard at the updated time, and to change the speed of the first vehicle according to the revised velocity profile.

7. The system of claim 6, wherein the control unit is further configured to select the revised velocity profile for the first vehicle so that travel of the first vehicle according to the revised velocity profile would result in less fuel used than travelling according to the current velocity profile.

8. The system of claim 6, wherein the one or more criteria comprises travel of the first vehicle according to the revised velocity profile not affecting the movement of the at least one second vehicle.

9. A method comprising:
receiving an updated time of entry into a vehicle yard at a first vehicle that is moving along a route of a transportation network that includes the vehicle yard, wherein the updated time is received from off-board the first vehicle; and
changing a speed of the first vehicle in response to the updated time of entry.

10. The method of claim 9, wherein the first vehicle is previously scheduled to enter into the vehicle yard at a previous time and the updated time is subsequent to the previous time, and changing the speed includes decreasing the speed of the first vehicle based on the updated time of entry.

11. The method of claim 9, wherein changing the speed comprises providing the updated time of entry to an energy management system disposed on-board the first vehicle, revising by the energy management system of a trip plan of the first vehicle based on the updated time of entry to form a revised trip plan, and controlling movement of the first vehicle based on the revised trip plan.

12. The method of claim 9, further comprising receiving from off-board the first vehicle one or more scheduled waypoints between a current location of the first vehicle and the vehicle yard, each of the one or more scheduled waypoints being defined by a location of the waypoint and a scheduled time of arrival of the first vehicle at the waypoint, wherein the speed of the first vehicle is changed to meet the one or more scheduled waypoints and to arrive at the vehicle yard at the updated time.

13. The method of claim 9, further comprising receiving at the first vehicle information of movement of at least one second vehicle in the transportation network, wherein the speed of the first vehicle is changed to meet one or more criteria relating to the movement of the at least one second vehicle and to arrive at the vehicle yard at the updated time.

14. The method of claim 13, further comprising selecting a revised velocity profile for the first vehicle, relative to a current velocity profile of the first vehicle, that meets the one or more criteria relating to the movement of the at least one second vehicle and for arrival of the first vehicle at the vehicle yard at the updated time, wherein the speed of the first vehicle is changed according to the revised velocity profile.

15. The method of claim 14, wherein the revised velocity profile for the first vehicle is selected so that travel of the first vehicle according to the revised velocity profile would result in less fuel used than travelling according to the current velocity profile.

16. A system comprising:
a monitoring module configured to track a capacity of a vehicle yard in a transportation network to receive vehicles for layover in the vehicle yard over time; and
a scheduling module configured to determine an updated time of entry for a first vehicle to enter the vehicle yard based on the capacity of the vehicle yard at the updated time of entry, wherein the scheduling module is configured to communicate the updated time of entry to the first vehicle so that the first vehicle can change speed as the first vehicle moves toward the vehicle yard.

17. The system of claim 16, wherein the scheduling module is configured to delay a previously scheduled time of entry of the first vehicle to enter into the vehicle yard to the updated time of entry based on an expected capacity of the vehicle yard to receive the first vehicle at the updated time of entry.

18. The system of claim 16, wherein the scheduling module is configured to receive information of a size of the first vehicle and to determine the updated time of entry based on the size of the first vehicle.

19. The system of claim 16, wherein the scheduling module is configured to determine the updated time of entry based on a throughput parameter of the transportation network that is representative of a flow of vehicles through the transportation network.

20. The system of claim 19, wherein the scheduling module is configured to communicate the updated time only if the first vehicle changing speed to arrive at the vehicle yard at the updated time would not result in the throughput parameter falling below a predetermined threshold.

21. The system of claim 16, wherein the scheduling module is configured to determine the updated time of entry based on travel of one or more other, second vehicles traveling along a route of the first vehicle subsequent to the first vehicle.

22. The system of claim 16, wherein the scheduling module is configured to determine the updated time of entry based on a number of one or more siding route sections or divergent route sections joined with a route that the first vehicle is traveling on toward the vehicle yard between a location of the first vehicle and the vehicle yard.

23. The system of claim 16, wherein the scheduling module is configured to communicate the updated time of entry to an energy management system disposed on-board the first vehicle for use of the updated time of entry by the energy management system to form a trip plan for controlling the first vehicle.

24. The system of claim 16, wherein the scheduling module is configured to determine the updated time of entry as the first vehicle is moving toward the vehicle yard.

25. The system of claim 16, wherein the scheduling module is configured to receive information of plural other vehicles in the transportation network that are traveling to the vehicle yard for layover in the vehicle yard, and to determine the capacity of the vehicle yard at the updated time of entry based on the information of the plural other vehicles.

26. The system of claim 16, wherein:
the monitoring module is configured to monitor movement of at least one second vehicle in the transportation network; and
the scheduling module is configured to one of:
select a revised velocity profile for the first vehicle, relative to a current velocity profile of the first vehicle, that meets one or more criteria relating to the movement of the at least one second vehicle and for arrival of the first vehicle at the vehicle yard at the updated time; or
communicate information of the movement of the at least one second vehicle to the first vehicle for a control unit on the first vehicle to select the revised velocity profile.

27. The system of claim 26, wherein the scheduling module or the control module is configured to select the revised velocity profile for the first vehicle so that travel of the first vehicle according to the revised velocity profile would result in less fuel used than travelling according to the current velocity profile.

28. The system of claim 16, wherein the scheduling module is configured to generate different sets of schedules for the vehicles to travel with at least one of the schedules in the different sets including the updated time of entry, and wherein the monitoring module is configured to simulate travel of the vehicles according to the different sets of schedules and to calculate throughput parameters associated with the different sets of schedules.

29. The system of claim 28, further wherein the scheduling module is configured to communicate at least one of the sets of schedules to the vehicles based on a comparison between the throughput parameters associated with the different sets of schedules.

30. The system of claim 16, wherein the scheduling module is configured to communicate the updated time of entry to the first vehicle only when a confidence parameter associated with the updated time of entry exceeds a designated threshold, the confidence parameter representative of a probability that directing the first vehicle to arrive at the vehicle yard at the updated time of entry will not negatively impact a throughput parameter of the vehicles.

31. A method comprising:
tracking a capacity of a vehicle yard to receive vehicles over time;
determining an updated time of entry for a first vehicle to enter the vehicle yard based on the capacity of the vehicle yard at the updated time of entry; and
communicating the updated time of entry to the first vehicle so that the first vehicle can change speed as the first vehicle moves toward the vehicle yard.

32. The method of claim 31, wherein determining the updated time of entry includes delaying a previously scheduled time of entry of the first vehicle to enter into the vehicle yard to the updated time of entry based on an expected capacity of the vehicle yard to receive the first vehicle at the updated time of entry.

33. The method of claim 31, wherein tracking the capacity includes monitoring a size of the first vehicle and the updated time of entry is based on the size of the first vehicle.

34. The method of claim 31, wherein the first vehicle travels toward the vehicle yard in a transportation network and the updated time of entry is based on a throughput parameter of the transportation network that is representative of a flow of vehicles through the transportation network.

35. The method of claim 31, wherein the updated time of entry is based on travel of one or more other, second vehicles traveling along the route subsequent to the first vehicle.

36. The method of claim 31, wherein the updated time of entry is based on a number of one or more siding route sections or divergent route sections joined with a route that the first vehicle is traveling on toward the vehicle yard between a location of the first vehicle and the vehicle yard.

37. The method of claim 31, wherein communicating the updated time of entry includes transmitting the updated time of entry to an energy management system disposed on-board the first vehicle for use of the updated time of entry by the energy management system to form a trip plan for controlling the first vehicle.

38. The method of claim 31, wherein determining the updated time of entry and communicating the updated time of entry occur as the first vehicle is moving toward the vehicle yard.

39. A system comprising:
a monitoring module configured to track a capacity of a vehicle yard to receive plural vehicles for layover in the vehicle yard over time, wherein the vehicle yard is part of a transportation network having plural routes over which the plural vehicles may travel, and wherein the monitoring module is further configured to monitor movement of a first vehicle and at least one second vehicle of the plural vehicles in the transportation network; and
a scheduling module configured to determine an updated time of entry for the first vehicle to enter the vehicle yard based on the capacity of the vehicle yard at the updated time of entry, and wherein the scheduling module is further configured to designate one or more scheduled waypoints between a current location of the first vehicle and the vehicle yard based on the updated time of entry and the movement of the first and second vehicles, each of the one or more scheduled waypoints being defined by a location of the waypoint and a scheduled time of arrival of the first vehicle at the waypoint, and wherein the one or more scheduled waypoints are designated such that movement of the first vehicle to arrive at the one or more scheduled waypoints as scheduled and enter the vehicle yard at the updated time of entry meets one or more criteria in regards to movement of the at least one second vehicle;
wherein the scheduling module is configured to communicate the updated time of entry and the one or more scheduled waypoints to the first vehicle for the first vehicle to change its speed to meet the scheduled waypoints and updated time of entry.
